(19) United States
(12) Patent Application Publication
(10) Pub. No.: US 2021/0406077 A1
(43) Pub. Date: Dec. 30, 2021

(54) METHOD AND SYSTEM FOR PARALLEL COMPUTATION

(71) Applicant: PHOTONICS ELECTRONICS TECHNOLOGY RESEARCH ASSOCIATION, Tokyo (JP)

(72) Inventor: Yutaka Urino, Tokyo (JP)

(21) Appl. No.: 16/646,901

(22) PCT Filed: Jul. 18, 2019
(86) PCT No.: PCT/JP2019/028252

§ 371 Date: Mar. 12, 2020

(51) Int. Cl. G06F 9/50; G06F 17/16; G06F 15/173

(52) U.S. Cl. CPC G06F 9/5027; G06F 15/173; G06F 17/16

(57) ABSTRACT

Speeding up of parallel computation is to be achieved. A parallel computation method comprises a step for distributing respective first-level small pieces of data, that are formed by dividing data, to respective computation nodes in plural computation nodes; a step for further dividing, in at least one first computation node in the plural computation nodes, the first-level small piece of data into second-level small pieces of data; a step for transferring, in parallel, the respective second-level small pieces of data from the at least one first computation node to the plural computation nodes; a step for transferring, in parallel, the transferred second-level small pieces of data from the respective computation nodes in the plural computation nodes to at least one second computation node in the plural computation nodes; and a step for reconstructing, in the at least one second computation node, the first-level small piece of data by using the second-level small pieces of data transferred from the plural computation nodes.

### TECHNICAL FIELD

The present invention relates to a method and a system for parallel computation.

### BACKGROUND ART

A system for performing parallel computation by use of plural computation nodes has been developed. An example of parallel computation is matrix product computation. The matrix product computation is one of the most basic computational elements that is widely used in scientific computation in general, analysis of big data, artificial intelligence, and so on.

Non-patent Literature 1, for example, has been known as that showing a prior-art method for obtaining a matrix product by performing parallel computation.

### CITATION LIST

### Non Patent Literature

NPL 1: Robert A. van de Geijn et al, “SUMMA: Scalable Universal Matrix Multiplication Algorithm,” Concurrency Practice and Experience 9(4), April 1997, pp. 255-274

### SUMMARY OF INVENTION

### Technical Problem

Speeding up of parallel computation is important for reducing the quantity of electric power consumption in a system such as a data center or the like.

The present invention has been achieved in view of the above matters; and an object of the present invention is to speed up parallel computation.

### Solution to Problem

For solving the above problem, a mode of the present invention provides a method for performing parallel computation in a parallel computation system comprising plural computation nodes, wherein the method comprises: a first step for distributing respective first-level small pieces of data, that are formed by dividing data, to the respective computation nodes in the plural computation nodes; a second step for further dividing, in a first group of computation nodes which includes at least one computation node in the plural computation nodes, the first-level small pieces of data into second-level small pieces of data; a third step for transferring, in parallel, the respective second-level small pieces of data from the first group of computation nodes to a group of relay nodes which is a subset of the plural computation nodes; a fourth step for transferring, in parallel, the transferred second-level small pieces of data from the group of relay nodes to a second group of computation nodes which includes at least one computation node in the plural computation nodes; and a fifth step for reconstructing, in the second group of computation nodes, the first-level small pieces of data by using the second-level small pieces of data transferred from the group of relay nodes.

Another mode of the present invention comprises the above mode, and provides the parallel computation method that further comprises a sixth step for performing a part of the parallel computation by using the reconstructed first-level small pieces of data.

Another mode of the present invention comprises the above mode, and provides the parallel computation method, wherein, in the parallel transfer from the first group of computation nodes in the third step, the first group of computation nodes transfer, in parallel, the respective second-level small pieces of data, in such a manner that all usable communication links between the first group of computation nodes and the group of relay nodes are used.

Another mode of the present invention comprises the above mode, and provides the parallel computation method, wherein, in the parallel transfer to the second group of computation nodes in the fourth step, the group of relay nodes transfer, in parallel, the respective second-level small pieces of data, in such a manner that all usable communication links between the group of relay nodes and the second group of computation nodes are used.

Another mode of the present invention comprises the above mode, and provides the parallel computation method, wherein each of the computation nodes comprises plural communication ports; and data communication from the first group of computation nodes to the group of relay nodes in the third step or data communication from the group of relay nodes to the second group of computation nodes in the fourth step is performed via the plural communication ports.

Another mode of the present invention comprises the above mode, and provides the parallel computation method, wherein the plural computation nodes are logically full-mesh connected.

Another mode of the present invention comprises the above mode, and provides the parallel computation method, wherein the parallel computation is matrix operation; the data is data representing a matrix; and the first-level small pieces of data are data representing submatrices formed by dividing the matrix along a row direction and a column direction.

Another mode of the present invention comprises the above mode, and provides the parallel computation method, wherein the submatrices are submatrices formed by dividing the matrix into N pieces (provided that N is the number of computation nodes); and the second-level small pieces of data are data formed by further dividing the submatrix into N pieces.

Another mode of the present invention comprises the above mode, and provides the parallel computation method, wherein the matrix operation is computation of a product of matrices.

Another mode of the present invention provides a method for performing parallel computation in a parallel computation system comprising plural computation nodes, wherein the method comprises: a step for further dividing each of first-level small pieces of data, that are formed by dividing data, into second-level small pieces of data; a step for distributing the respective second-level small pieces of data to the respective computation nodes in the plural computation nodes; a step for transferring, in parallel, the second-level small pieces of data from the respective computation nodes in the plural computation nodes to at least one computation node in the plural computation nodes; and a step for reconstructing, in the at least one computation node, the first-level small piece of data by using the second-level small pieces of data transferred from the plural computation nodes.

Another mode of the present invention provides a parallel computation system comprising plural computation nodes, wherein respective first-level small pieces of data, that are formed by dividing data, are distributed to the respective computation nodes in the plural computation nodes; at least one first computation node in the plural computation nodes is constructed to further divide the first-level small piece of data into second-level small pieces of data, and transfer, in parallel, the respective second-level small pieces of data to a group of relay nodes which is a subset of the plural computation nodes; and at least one second computation node in the plural computation nodes is constructed to obtain, by parallel transfer, the second-level small pieces of data from the group of relay nodes, and reconstruct the first-level small piece of data by using the second-level small pieces of data transferred from the group of relay nodes.

Another mode of the present invention provides a parallel computation system comprising plural computation nodes, wherein each of first-level small pieces of data, that are formed by dividing data, is further divided into second-level small pieces of data; the respective second-level small pieces of data are distributed to the respective computation nodes in the plural computation nodes; and at least one computation node in the plural computation nodes is constructed to obtain, by parallel transfer, the second-level small pieces of data from the respective computation nodes in the plural computation nodes, and reconstruct the first-level small piece of data by using the second-level small pieces of data transferred from the plural computation nodes.

### Advantageous Effects of Invention

According to the present invention, parallel computation can be performed at high speed.

### BRIEF DESCRIPTION OF DRAWINGS

FIG. 1 is a configuration diagram of a parallel computation system relating to an embodiment of the present invention.

FIG. 2 is a configuration diagram of a computation node relating to an embodiment of the present invention.

FIG. 3 shows an example of parallel computation that is an object of a parallel computation system relating to an embodiment of the present invention.

FIG. 4 is a flow chart showing operation of a parallel computation system which uses a prior-art algorithm (SUMMA).

FIG. 5 conceptually shows progress in matrix operation in a prior-art algorithm (SUMMA).

FIG. 6 shows tables showing routing of submatrices between computation nodes when using a prior-art algorithm (SUMMA).

FIG. 7 is a flow chart showing operation of a parallel computation system relating to a first embodiment of the present invention.

FIG. 8 shows tables showing routing between computation nodes in the first embodiment of the present invention.

FIG. 9 is a flow chart showing operation of a parallel computation system relating to a second embodiment of the present invention.

FIG. 10 shows tables showing routing between computation nodes in the second embodiment of the present invention.

FIG. 11 is a flow chart showing operation of a parallel computation system relating to a third embodiment of the present invention.

FIG. 12 shows tables showing routing between computation nodes in the third embodiment of the present invention.

FIG. 13 is a flow chart showing operation of a parallel computation system relating to a fourth embodiment of the present invention.

FIG. 14 shows initial distribution of data to each of computation nodes, and tables showing routing between computation nodes in the fourth embodiment of the present invention.

FIG. 15 is a table which summarizes performance of a parallel computation method using a prior-art algorithm and performance of a parallel computation method relating to each of the embodiments of the present invention.

FIG. 16 shows graphs showing results of measurement of run time in simulations of parallel computation.

FIG. 17 conceptually shows progress in matrix operation in a prior-art algorithm (Cannon algorithm).

FIG. 18 shows tables showing routing between computation nodes in a fifth embodiment of the present invention.

FIG. 19 conceptually shows progress in matrix operation in a prior-art algorithm (Fox algorithm).

FIG. 20 shows tables showing routing between computation nodes in a sixth embodiment of the present invention.

FIG. 21 is a configuration diagram of a parallel computation system relating to a seventh embodiment of the present invention.

FIG. 22 is a configuration diagram of a parallel computation system relating to an eighth embodiment of the present invention.

FIG. 23 is a table showing routing by a wavelength router.

FIG. 24 is a configuration diagram of a computation node applied to a parallel computation system relating to the eighth embodiment of the present invention.

### DESCRIPTION OF EMBODIMENTS

In the following description, embodiments of the present invention will be explained in detail, with reference to the figures.

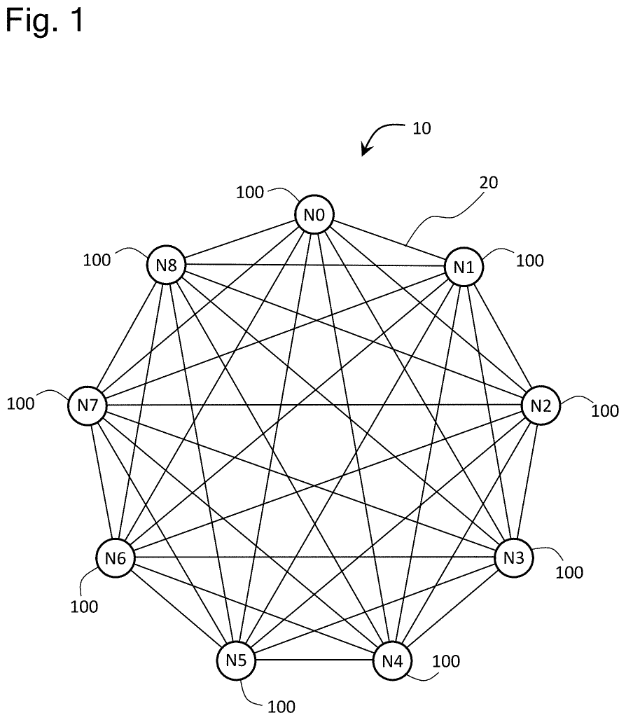

FIG. 1 is a configuration diagram of a parallel computation system 10 relating to an embodiment of the present invention. The parallel computation system 10 comprises plural computation nodes 100. FIG. 1 shows logical topology between computation nodes 100. Each computation node 100 is a computer which executes assigned predetermined calculation, in parallel with other computation nodes 100. In the example in FIG. 1, the parallel computation system 10 comprises nine computation nodes 100, specifically, a computation node N0, a computation node N1, a computation node N2, a computation node N3, a computation node N4, a computation node N5, a computation node N6, a computation node N7, and a computation node N8. In this regard, the above number of computation nodes 100 is a mere example, and the parallel computation system 10 may comprise any number of computation nodes 100, for example, several tens, several hundreds, or several thousands of computation nodes 100.

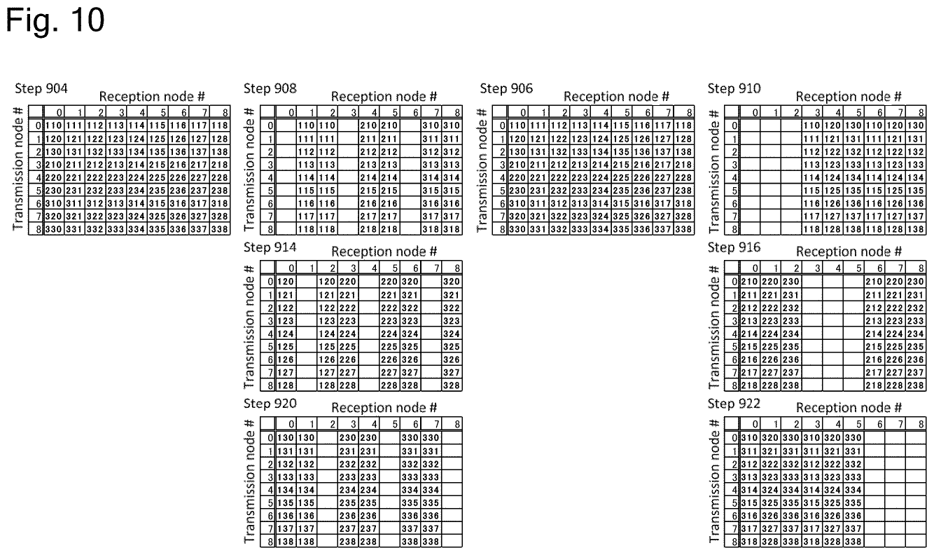

The respective computation nodes 100 are connected by communication links 20. The communication link 20 is a transmission path which allows transmission/reception of data between computation nodes 100 which are connected to ends of the communication link 20. The communication link 20 transmits data in the form of an electric signal or an optical signal. The communication link 20 may be wired or wireless. In the example in FIG. 10, the computation node N0 is connected, by the communication links 20, to all other computation nodes 100, i.e., the computation node N1, the computation node N2, the computation node N3, the computation node N4, the computation node N5, the computation node N6, the computation node N7, and the computation node N8. Similarly, each of the other computation nodes 100 is connected, by the communication links 20, to all other computation nodes 100. In this manner, in the parallel computation system 10 exemplified in FIG. 1, the respective computation nodes 100 are “full-mesh” connected by the communication links 20. In this regard, connection between the computation nodes 100 is not necessarily full mesh, and communication links 20 between some specific computation nodes 100 may be omitted. Communication between computation nodes 100, between which no communication link 20 exists, may be performed via another computation node 100, for example. In this specification, it should be reminded that, with respect to counting of the number of communication links 20, it is regarded that a single communication link is used for communication in a single direction. In FIG. 1, the respective communication links 20 for connection between the computation nodes 100 are represented by respective single lines for simplification; however, in actuality, since simultaneous bidirectional communication is possible between the computation nodes 100, two communication links 20 are used for connection between the respective computation nodes 100. Thus, the communication links 20 of 9*8=72 exist in the example in FIG. 1. It should be reminded that FIG. 1 shows that the logical topology between the computation nodes 100 is full-mesh connection, and that the physical topology between the computation nodes 100 is not necessarily full-mesh connection. The logical topology in the embodiment of the present invention is full-mesh connection such as that in a parallel computation system using wavelength routing that will be explained later; however, the physical topology includes a parallel computation system having a star connection configuration.

As explained above, the parallel computation system 10 relating to the embodiment of the present invention has the construction wherein the respective computation nodes 100 are logically full-mesh connected. In a prior-art parallel computation system 10 wherein the respective computation nodes 100 are connected via a packet switch, the links between the computation node 100 and the packet switch are used in a time division manner, so that the system is highly flexible; however, it is required to perform a complicated procedure for avoiding collision between packets, and such procedure is a cause of delay in communication and increase in consumed electric power. On the other hand, in the parallel computation system 10 of the present embodiment wherein the respective computation nodes 100 are logically full-mesh connected, all computation nodes 100 are always directly connected with each other, so that it is not required to consider collision between packets, and becomes possible to adopt a simpler process; thus, communication delay and electric power consumption can be reduced.

In the case that specific computation is performed, the parallel computation system 10 divides a process for the computation into plural processes, and assigns the divided sub-processes to the respective computation nodes 100. That is, each computation node 100 is in charge of a part of the computation that is performed as a whole by the parallel computation system 10. Further, the parallel computation system 10 divides data, that is used in computation or is an object of computation, into plural pieces of data, and distributes the divided small pieces of data to respective computation nodes 100. Although each computation node 100 performs computation that the computation node is in charge of, the computation node may not hold data required for the computation. The computation node 100 obtains, via the communication link 20, such data from the other computation node 100 which holds the data. As explained above, each of the computation nodes 100 performs sub-process assigned to the computation node, so that computation in the parallel computation system 10 is processed, in a parallel manner, by cooperation of plural computation nodes 100.

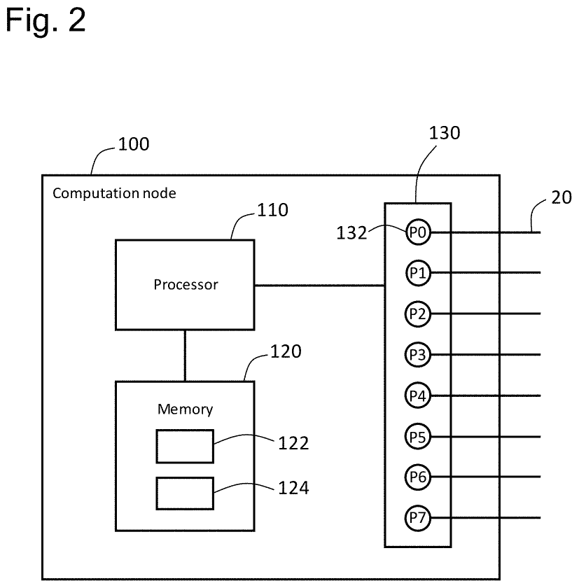

FIG. 2 is a configuration diagram of a computation node 100 relating to an embodiment of the present invention. FIG. 2 shows a construction of the computation node 100 in the plural computation nodes 100 in FIG. 1. Each of other computation nodes 100 in the plural computation nodes 100 may have a construction identical to that shown in FIG. 2, or may be constructed to be different from that shown in FIG. 2.

In FIG. 2, the computation node 100 comprises a processor 110, a memory 120, and a transmission/reception unit 130. The memory 120 comprises, at least, a program storage area 122 and a data storage area 124. A computer program that makes the computation node 100 to perform operation, that will be explained later, relating to an embodiment of the present invention is stored in the program storage area 122. The processor 110 reads the computer program out of the program storage area 122 and executes it, and, as a result, the computation node 100 performs operation, that will be explained later, relating to an embodiment of the present invention.

A small piece of data, that is one of small pieces of data formed by dividing entire data used for parallel computation and is designated to be distributed to the computation node 100, is stored in the data storage area 124 in advance. Further, a small piece of data, that is required by the computation node 100 for computation and is obtained from the other computation node 100, is stored in the data storage area 124 temporarily. Further, data generated as a result of execution of computation by the computation node 100 is also stored in the data storage area 124.

The transmission/reception unit 130 transmits/receives, between the computation node 100 and other computation nodes 100, small pieces of data that are required by the respective computation nodes 100 for computation. Specifically, the transmission/reception unit 130 transmits a small piece of data, that is distributed to the computation node 100 and stored in the data storage area 124 of the memory 120 in advance, to the other computation node 100 to be used for computation in the other computation node 100. Further, the transmission/reception unit 130 receives a small piece of data, that is not held in the computation node 100 and is necessary for computation, from the other computation node 100.

The transmission/reception unit 130 comprises plural communication ports 132 for transmitting/receiving, in parallel, data to/from the respective ones of plural computation nodes 100. The respective communication ports 132 are connected to the respective corresponding computation nodes 100 via communication links 20. In the example in FIG. 2, the transmission/reception unit 130 comprises eight communication ports 132. For example, when attention is directed to the computation node N0, it can be seen that the communication port P0 is connected to the computation node N1, the communication port P1 is connected to the computation node N2, the communication port P2 is connected to the computation node N3, the communication port P3 is connected to the computation node N4, the communication port P4 is connected to the computation node N5, the communication port P5 is connected to the computation node N6, the communication port P6 is connected to the computation node N7, and the communication port P7 is connected to the computation node N8. Regarding the computation nodes 100 other than the computation node N0, the respective communication ports 132 are connected to other respective computation nodes 100 in a similar manner. Thus, each computation node 100 can transmit data simultaneously to other computation nodes 100, and can receive data simultaneously from other computation nodes 100. By making each computation node 100 to have multiple communication ports 132 having relatively small granularity, and to be connected to other computation nodes 100 via multiple communication links 20, high availability can be expected since, even if a communication port 132 is broken down, communication can be continued by using other communication ports 132 and communication links 20.

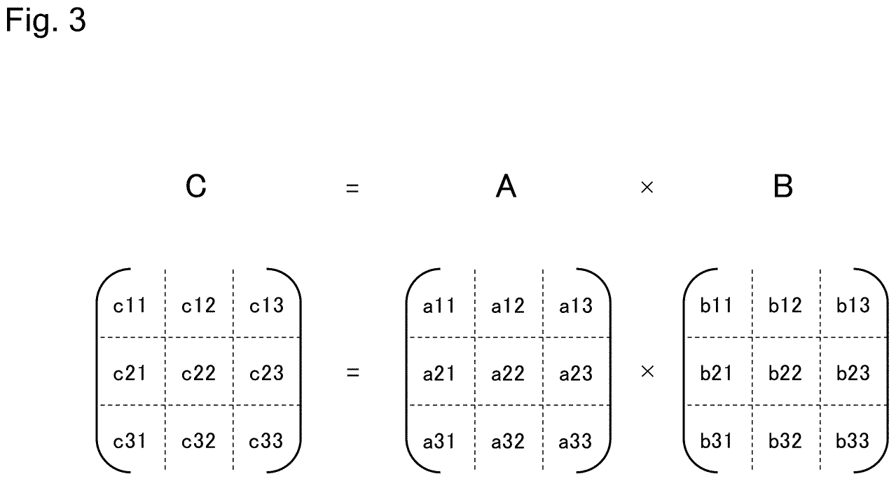

FIG. 3 shows an example of parallel computation that is an object of the parallel computation system 10 relating to an embodiment of the present invention. The parallel computation system 10 can execute a process for computation of a product of matrices C=A*B of a matrix A and a matrix B. In this regard, parallel computation that can be applied to the parallel computation system 10 is not limited to computation of a product of matrices. Data A and data B are not necessarily matrices. Further, computation may be that using a single piece of data (for example, data A) only or that using three or more pieces of data, rather than that using two pieces of data (i.e., A and B). The parallel computation system 10 can regard, as an object to be handled thereby, any kind of parallel computation that can be executed in such a manner that at least a piece of data (for example, data A) is divided into small pieces of data and they are distributed to plural computation nodes 100, and each computation node 100 obtains small pieces of data, that are required for computation, from the other computation nodes 100.

In the following description, embodiments of the present invention will be explained in relation to computation of a product of matrices. In the case that the number of computation nodes 100 is N (=p*q, wherein p and q are natural numbers), each of the matrices A and B is divided into p parts in the row direction and q parts in the column direction. Although it is not necessary to set p=q, the case wherein p=q, i.e., N=p², will be explained in the following description; this is because the number of times of communication of the matrix A and that of the matrix B coincide with each other if p=q, so that computation can be performed most efficiently. To be able to compute matrix multiplication A*B with respect to the matrix A and the matrix B, it is required that the number of columns of the matrix A and the number of rows of the matrix B be the same. Thus, it is supposed that the matrix A has I rows and K columns and the matrix B has K rows and J columns. In such a case, the number of rows and the number of columns of each of submatrices, that are formed by dividing the matrix A into N (=p²) parts, are I/p and K/p, respectively; and the number of rows and the number of columns of each of submatrices, that are formed by dividing the matrix B into N (=p²) parts, are K/p and J/p, respectively. Thus, the number of columns of the submatrix of the matrix A and the number of rows of the submatrix of the matrix B coincide with each other, so that a product of matrices with respect to the submatrix of the matrix A and the submatrix of the matrix B can be calculated. For example, in the case of the parallel computation system 10 in FIG. 1, N=9, since the number of computation node is 9, and p=3, so that each of the matrix A and the matrix B is divided into three parts in the row direction and three parts in the column direction. Specifically, as shown in FIG. 3, the submatrices in the matrix A are defined as a11, a12, a13, a21, a22, a23, a31, a32, and a33. Similarly, the submatrices in the matrix B are defined as b11, b12, b13, b21, b22, b23, b31, b32, and b33. Note that, based on the above supposition, the number of rows and the number of columns in each submatrix cij of a matrix C are I/p and J/p, respectively. Each submatrix cij of the matrix C can be calculated by using the following formula. Each computation node 100 of the parallel computation system 10 is in charge of processing for computing one of the nine submatrices cij.

cij=Σₖ(aik*bkj)

(provided that i=1, 2, and 3; j=1, 2, and 3; and k=1, 2, and 3)

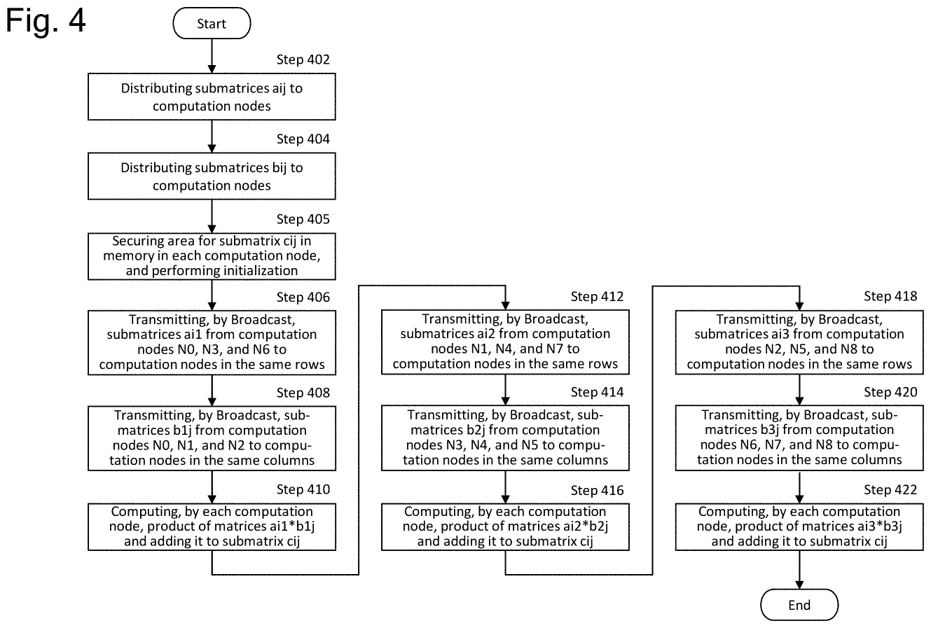

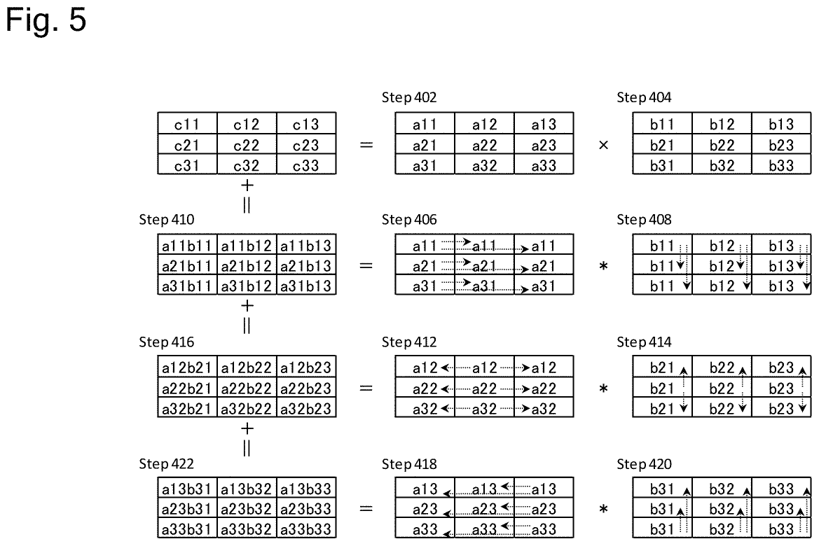

First, an algorithm for parallel computation, that has been known, will be explained. FIG. 4 is a flow chart showing operation of the parallel computation system 10 in the case that SUMMA (Scalable Universal Matrix Multiplication Algorithm), that is one of prior-art parallel computation algorithms, is adopted therein. Also, FIG. 5 is a conceptual drawing that shows how each computation node 100 of the parallel computation system 10 proceeds matrix operation by using SUMMA. FIG. 5 shows some boxes, wherein each box has nine cells arranged in three rows and three columns. In the nine cells which are arranged in three rows and three columns in each box, the upper left cell represents the computation node N0, the upper center cell represents the computation node N1, the upper right cell represents the computation node N2, the middle left cell represents the computation node N3, the middle center cell represents the computation node N4, the middle right cell represents the computation node N5, the lower left cell represents the computation node N6, the lower center cell represents the computation node N7, and the lower right cell represents the computation node N8.

First, in step 402, respective submatrices aij of the matrix A are distributed to respective corresponding computation nodes Nn (provided that n=3(i−1)+j−1). Specifically, as shown in FIG. 5, the submatrix a11 is arranged to be positioned in the computation node N0, the submatrix a12 is arranged to be positioned in the computation node N1, the submatrix a13 is arranged to be positioned in the computation node N2, the submatrix a21 is arranged to be positioned in the computation node N3, the submatrix a22 is arranged to be positioned in the computation node N4, the submatrix a23 is arranged to be positioned in the computation node N5, the submatrix a31 is arranged to be positioned in the computation node N6, the submatrix a32 is arranged to be positioned in the computation node N7, and the submatrix a33 is arranged to be positioned in the computation node N8. In this regard, the expression such as “is arranged to be positioned in the computation node 100” means that data is stored in the data storage area 124 in the memory 120 in the computation node 100.

Next, in step 404, respective submatrices bij of the matrix B are distributed to respective corresponding computation nodes Nn, similarly.

Next, in step 405, each computation node Nn secures a part of the data storage area 124 in its memory 120 as an area for storing the submatrix cij, and initializes all elements of the submatrix cij by 0. In this case, indexes i and j of the submatrix cij are represented by i=n/3+1 and j=n %3+1, respectively. In this regard, n/3 means the integer part of the quotient obtained by dividing n by 3, and n %3 means the remainder obtained when n is divided by 3.

At this point, the computation node N0, for example, merely holds the submatrix all of the matrix A and the submatrix b11 of the matrix B. Thus, the computation node N0 cannot yet perform computation of submatrix c11, that the computation node N0 is in charge of, in computation of the matrices product C. The matters similar to the above matters also apply to other computation nodes 100. The above is the preparation stage before performing the following repeated processes. In the following process, three times of repeated processes, i.e., steps 406-410, steps 412-146, and steps 418-422 are performed.

In the repeated processes of the first time, in step 406, each of the computation nodes N0, N3, and N6 transmits, by “Broadcast communication,” a submatrix, that is held thereby, of the matrix A to other two computation nodes 100 “in the same row.” The expression “in the same row” means that they belong to the same row in the box shown in FIG. 5. For example, the computation node N0, the computation node N1, and the computation node N2 exist in the same row. Also, “Broadcast communication” is communication for transmitting the same data from a computation node 100 to other plural computation nodes 100. More specifically, the computation node N0 transmits the submatrix a11 to the computation node N1 and the computation node N2, the computation node N3 transmits the submatrix a21 to the computation node N4 and the computation node N5, and the computation node N6 transmits the submatrix a31 to the computation node N7 and the computation node N8.

Next, in step 408, each of the computation nodes N0, N1, and N2 transmits, by Broadcast communication, a submatrix, that is held thereby, of the matrix B to other two computation nodes 100 “in the same column.” The expression “in the same column” means that they belong to the same column in the box shown in FIG. 5. For example, the computation node N0, the computation node N3, and the computation node N6 exist in the same column. More specifically, the computation node N0 transmits the submatrix b11 to the computation node N3 and the computation node N6, the computation node N1 transmits the submatrix b12 to the computation node N4 and the computation node N7, and the computation node N2 transmits the submatrix b13 to the computation node N5 and the computation node N8.

Next, in step 410, each computation node Nn computes a product of matrices ai1*b1j of two submatrices (provided that i=n/3+1 and J=n %3+1), that is a part of calculation that the computation node is in charge of. For example, the computation node N0 uses the submatrix a11 and the submatrix b11 that have been stored in the data storage area 124 in the memory 120 in step 402 and step 404, respectively, for calculating a product of matrices a11*b11. Also, the computation node N1 uses the submatrix b12 that has been stored in the data storage area 124 in the memory 120 in step 404 and the submatrix a11 that has been obtained from the computation node N0 in step 406, for calculating a product of matrices a11*b12. Also, for example, the computation node N4 uses the submatrix a21 that has been obtained from the computation node N3 in step 406 and the submatrix b12 that has been obtained from the computation node N1 in step 408, for calculating a product of matrices a21*b12. Regarding other computation nodes 100, refer to FIG. 5. Each computation node Nn adds, element by element, each element in the product of matrices ai1*b1j obtained by computation to each element of the submatrix cij in the data storage area 124 in the memory 120 in each computation node. As a result, data of ai1*b1j is stored, as interim progress data of the submatrix cij at the time, in the data storage area 124 in the memory 120 in each computation node Nn.

In the repeated processes of the second time, in step 412, each of the computation nodes N1, N4, and N7 transmits, by Broadcast communication, a submatrix, that is held thereby, of the matrix A to other two computation nodes 100 in the same row. Specifically, the computation node N1 transmits the submatrix a12 to the computation node N0 and the computation node N2, the computation node N4 transmits the submatrix a22 to the computation node N3 and the computation node N5, and the computation node N7 transmits the submatrix a32 to the computation node N6 and the computation node N8.

Next, in step 414, each of the computation nodes N3, N4, and N5 transmits, by Broadcast communication, a submatrix, that is held thereby, of the matrix B to other two computation nodes 100 in the same column. Specifically, the computation node N3 transmits the submatrix b21 to the computation node N0 and the computation node N6, the computation node N4 transmits the submatrix b22 to the computation node N1 and the computation node N7, and the computation node N5 transmits the submatrix b23 to the computation node N2 and the computation node N8.

Next, in step 416, in a manner similar to that in step 410, each computation node Nn calculates a product of matrices ai2*b2j of two submatrices, that is a part of calculation that the computation node is in charge of; and adds, element by element, each element in the obtained product of matrices ai2*b2j to each element of the submatrix cij in the data storage area 124 in the memory 120 in the computation node. Although details are omitted for avoiding complication in the above explanations, a person skilled in the art can easily understand, based on the above explanation relating to step 410 and the description in FIG. 5, tangible contents of computation in step 416. As a result of step 416, data of ai1*b1j+ai2*b2j is stored, as interim progress data of the submatrix cij at the time, in the data storage area 124 in the memory 120 in each computation node Nn.

In the repeated processes of the third time, in step 418, each of the computation nodes N2, N5, and N8 transmits, by Broadcast communication, a submatrix, that is held thereby, of the matrix A to other two computation nodes 100 in the same row. Specifically, the computation node N2 transmits the submatrix a13 to the computation node N0 and the computation node N1, the computation node N5 transmits the submatrix a23 to the computation node N3 and the computation node N4, and the computation node N8 transmits the submatrix a33 to the computation node N6 and the computation node N7.

Next, in step 420, each of the computation nodes N6, N7, and N8 transmits, by Broadcast communication, a submatrix, that is held thereby, of the matrix B to other two computation nodes 100 in the same column. Specifically, the computation node N6 transmits the submatrix b31 to the computation node N0 and the computation node N3, the computation node N7 transmits the submatrix b32 to the computation node N1 and the computation node N4, and the computation node N8 transmits the submatrix b33 to the computation node N2 and the computation node N5.

Next, in step 422, in a manner similar to that in each of step 410 and step 416, each computation node Nn calculates a product of matrices ai3*b3j of two submatrices, that is a part of calculation that the computation node is in charge of and adds, element by element, each element in the obtained product of matrices ai3*b3j to each element of the submatrix cij in the data storage area 124 in the memory 120 in the computation node. Regarding tangible contents of computation, refer to the above explanation relating to step 410 and the description in FIG. 5. As a result of step 422, data of ai1*b1j+ai2*b2j+ai3*b3j is stored, as final data of the submatrix cij, in the data storage area 124 in the memory 120 in each computation node Nn.

As a result, each computation node 100 obtains a result of computation with respect to the submatrix cij that is a part of the matrix C that represents the product of matrices A*B and that the computation node in charge of computation thereof.

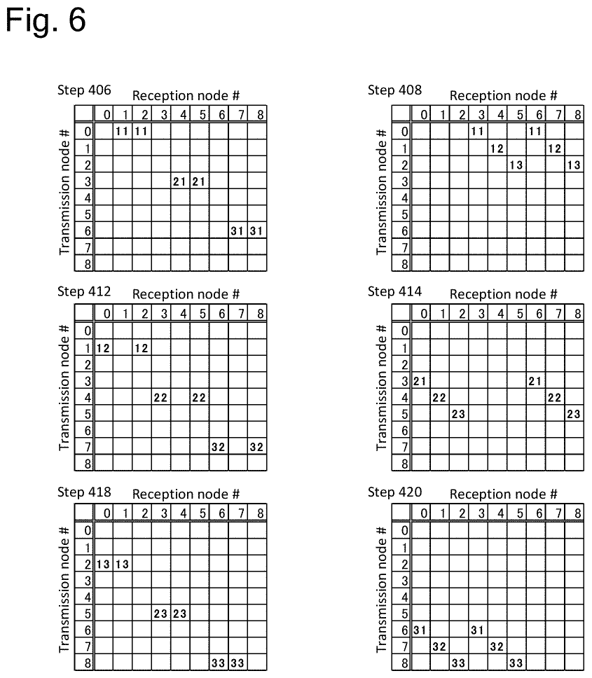

FIG. 6 visually shows, in the forms of tables, how the submatrices are routed between the computation nodes 100, in each of steps 406, 408, 412, 414, 418, and 420 in the above-explained prior-art algorithm. The respective computation nodes 100 at transmission sides are shown in the vertical direction in the tables, and the respective computation nodes 100 at reception sides are shown in the horizontal direction in the tables. Each cell in which a number such as “11” or the like is written represents a state that a submatrix has been transferred between a transmission-side computation node 100 and a reception-side computation node 100 corresponding to the cell, that is, the state that a communication link 20 between the two computation nodes 100 has been used. A blank cell represents a state that a submatrix has not been transferred between a transmission-side computation node 100 and a reception-side computation node 100 corresponding to the cell, that is, the state that a communication link 20 between the two computation nodes 100 has not been used. The numeral “ij” represents a submatrix aij or bij.

For example, in the table shown as step 406 in FIG. 6, the numeral “11” described in the second cell, when viewed from the left side, in the top row represents a state that the submatrix a11 has been transferred between the transmission-side computation node N0 and the reception-side computation node N1 via the communication link 20; and the numeral “21” described in the fifth cell, when viewed from the left side, in the fourth row, when viewed from the top side, represents a state that the submatrix a21 has been transferred between the transmission-side computation node N3 and the reception-side computation node N4 via the communication link 20. Regarding transferring of these submatrices, explanation thereof is the same as that relating to step 406. Regarding any other numerals “ij” described in respective tables in FIG. 6, they can be understood similarly.

As shown in FIG. 6, in the above-explained prior-art algorithm, the number of the communication links 20 that are used simultaneously in respective steps 406, 408, 412, 414, 418, and 420 is 12, in the total of 72 (=9*8) communication links 20 which mutually connect nine computation nodes 100 in the parallel computation system 10. The remaining 60 communication links 20 are not used in the respective steps. That is, the whole communication band of the parallel computation system 10 is not effectively used. Thus, in the embodiments of the present invention which will be explained later, speeding up of parallel computation is realized by increasing efficiency of utilization of the communication band of the parallel computation system 10.

In this regard, in the above explanation, an example wherein a matrix is divided into 3*3=9 submatrices and they are distributed to nine computation nodes 100 has been explained. However, the number by which a matrix is divided and the number of computation nodes 100 are not limited to those in the above example. When it is generalized, it is possible to divide a matrix into p*p=p² (p is an integer equal to or greater than 2) submatrices, and distribute them to p² computation nodes Nn (provided that n=0, 1, . . . , p²-1). In the case of the operation show by the flow chart in FIG. 4, three repeated processes, i.e., steps 406-410, steps 412-416, and steps 418-422, are performed; however, in the generalized operation wherein the number by which a matrix is divided is p², a total of p times of similar repeated processes are performed.

A repeated process at the m-th time (m=1, 2, . . . , p) in p times of repeated processes is performed in the following manner. That is, first, as operation corresponding to step 406 in the flow chart in FIG. 4, each computation node Nn (provided that n=i*p+m−1, and i=0, 1, . . . , p−1) transmits, by Broadcast communication, a submatrix aim (provided that i=n/3+1), that is held thereby, of a matrix A to other computation nodes in the same row. Next, as operation corresponding to step 408 in the flow chart in FIG. 4, each computation node Nn (provided that n=p*(m−1)+j, and j=0, 1, . . . , p−1) transmits, by Broadcast communication, a submatrix bmj (provided that j=n %3+1), that is held thereby, of a matrix B to other computation nodes in the same column. Thereafter, as operation corresponding to step 410 in the flow chart in FIG. 4, each computation node Nn (provided that n=0, 1, . . . , p²−1) computes a product of matrices aim*bmj and adds it to the submatrix cij in the memory 120. In this manner, in each of p repeated processes, Broadcast communication is performed two times, so that a total number of times of communication is 2*p.

### First Embodiment

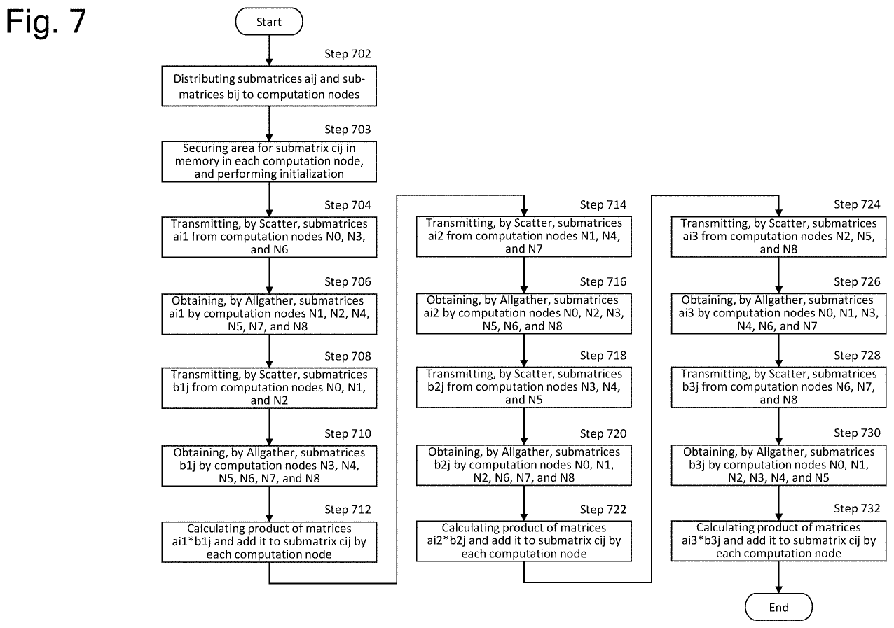

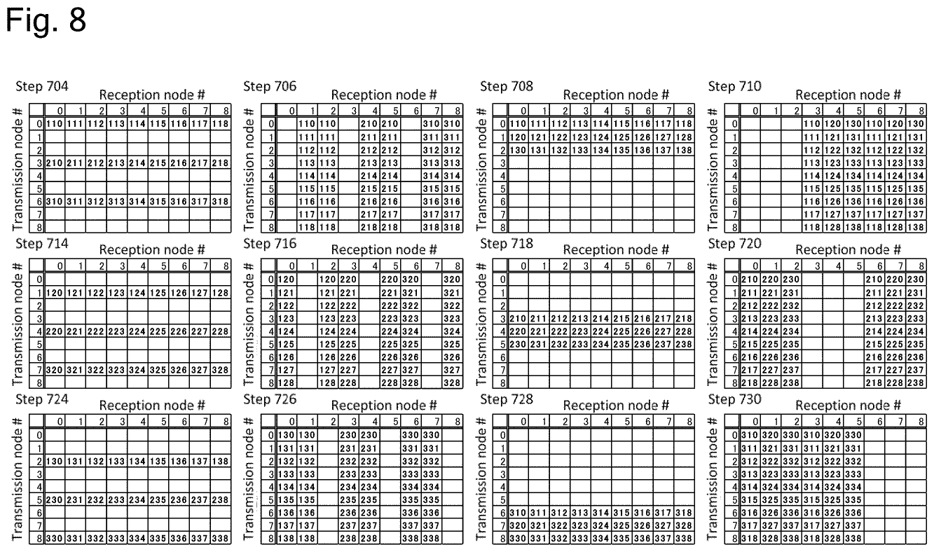

FIG. 7 is a flow chart showing operation of a parallel computation system 10 relating to a first embodiment of the present invention. Also, FIG. 8 visually shows, in the forms of tables, how submatrices are routed between the computation nodes 100 in the first embodiment of the present invention, and the figure corresponds to the above explained FIG. 6 in the prior-art example.

First, in step 702, respective submatrices aij of a matrix A and respective submatrices bij of a matrix B are arranged to be positioned in respective corresponding computation nodes 100. This step is the same as steps 402 and 404 in the above-explained prior-art example.

Next, in step 703, similar to the case of step 405 in the prior-art example, each computation node 100 secures a part of the data storage area 124 in its memory 120 as an area for storing the submatrix cij, and initializes all elements of the submatrix cij by 0.

Next, in step 704, each of the computation nodes N0, N3, and N6 transmits a submatrix, that is held thereby, of the matrix A to all computation nodes 100 by “Scatter communication.” The “Scatter communication” is communication wherein data held by a computation node 100 is divided into small pieces of data, and respective small pieces of data are transmitted to respective corresponding computation nodes 100, so that parts, that are different from each other, of the original data are distributed to different computation nodes 100.

Specifically, for example, the computation node N0 divides a submatrix a11 into nine small pieces of data a110, a111, a112, a113, a114, a115, a116, a117, and a118; and transmits the small piece of data a111 to the computation node N1, transmits the small piece of data a112 to the computation node N2, transmits the small piece of data a113 to the computation node N3, transmits the small piece of data a114 to the computation node N4, transmits the small piece of data a115 to the computation node N5, transmits the small piece of data a116 to the computation node N6, transmits the small piece of data a117 to the computation node N7, and transmits the small piece of data a118 to the computation node N8. Also, the computation node N3 divides a submatrix a21 into nine small pieces of data and transmits the respective small pieces of data to other computation nodes 100, in a similar manner. The computation node N6 also performs operation similar to the above operation. In the table shown as step 704 in FIG. 8, transferring of the above small pieces of data is shown by use of numerals “ijk.” In FIG. 8, the numeral “ijk” represents the k-th small piece of data (k=0, 1, . . . , 8) in the small pieces of data formed by dividing a submatrix aij or bij.

Next, in step 706, the respective computation nodes N1, N2, N4, N5, N7, and N8 collect the small pieces of data, that have been distributed to the respective computation nodes 100 in above step 704, by performing “Allgather communication,” and reconstruct the submatrices of the matrix A by use of the collected small pieces of data, respectively. The “Allgather communication” is that by which plural processes, wherein each process is that for collecting pieces of data distributed to plural computation nodes 100 and combining the pieces of data by a single computation node 100, are performed in parallel.

Specifically, for example, the computation node N1 obtains small pieces of data a110, a111, a112, a113, a114, a115, a116, a117 and a118 from computation nodes N0, N1, N2, N3, N4, N5, N6, N7, and N8, respectively, and reconstructs the submatrix a11 of the matrix A by use of the above small pieces of data. The above transferring of the respective small pieces of data from the respective computation nodes 100 to the computation node N1 is shown in the second column, when viewed from the left side, of the table shown as step 706 in FIG. 8. Similarly, the computation node N2 reconstructs the submatrix all, each of the computation nodes N4 and N5 reconstructs the submatrix a21, and each of the computation nodes N7 and N8 reconstructs the submatrix a31.

As a result that steps 704 and 706 are performed as explained above, each of the computation nodes N0, N1, and N2 is made to be in the state that it holds the submatrix a11 of the matrix A, each of the computation nodes N3, N4, and N5 is made to be in the state that it holds the submatrix a21 of the matrix A, and each of the computation nodes N6, N7, and N8 is made to be in the state that it holds the submatrix a31 of the matrix A, similar to the case that when step 406 in the above-explained prior-art algorithm is completed. When step 406 in the prior-art algorithm and steps 704 and 706 in the present embodiment are compared, it is worth to note that, although the number of communication steps is doubled in the present embodiment, the number of used communication links 20 is increased nine-fold, and the size of data transmitted through each communication link 20 is decreased to 1/9 of that of the prior art, so that communication time required for transferring a submatrix is shortened to 2/9 of that of the prior art.

Next, in step 708, each of the computation nodes N0, N1, and N2 transmits a submatrix, that is held thereby, of the matrix B to all computation nodes 100 by performing Scatter communication. Specifically, as shown in the table of step 708 in FIG. 8, the computation node N0 divides a submatrix b11 into nine small pieces of data, and transmits the small pieces of data b111, b112, b113, b114, b115, b116, b117, and b118 to the computation nodes N1, N2, N3, N4, N5, N6, N7, and N8, respectively. Similarly, the computation node N1 transmits small pieces of data, that are formed by dividing the submatrix b12, to the respective computation nodes 100; and the computation node N2 transmits small pieces of data, that are formed by dividing the submatrix b13, to the respective computation nodes 100.

Next, in step 710, the respective computation nodes N3, N4, N5, N6, N7, and N8 collect the small pieces of data, that have been distributed to the respective computation nodes 100 in above step 708, by performing “Allgather communication,” and reconstruct the submatrices of the matrix B by use of the collected small pieces of data, respectively. Specifically, for example, the computation node N3 obtains small pieces of data b110, b111, b112, b113, b114, b115, b116, b117, and b118 from computation nodes N0, N1, N2, N3, N4, N5, N6, N7, and N8, respectively, and reconstructs the submatrix b11 of the matrix B by use of the above small pieces of data. The above transferring of the respective small pieces of data from the respective computation nodes 100 to the computation node N3 is shown in the fourth column, when viewed from the left side, of the table shown as step 710 in FIG. 8. Similarly, the computation node N6 reconstructs the submatrix b11, each of the computation nodes N4 and N7 reconstructs the submatrix b12, and each of the computation nodes N5 and N8 reconstructs the submatrix b13.

As a result that steps 708 and 710 are performed as explained above, each of the computation nodes N0, N3, and N6 is made to be in the state that it holds the submatrix b11 of the matrix B, each of the computation nodes N1, N4, and N7 is made to be in the state that it holds the submatrix b12 of the matrix B, and each of the computation nodes N2, N5, and N8 is made to be in the state that it holds the submatrix b13 of the matrix B, similar to the case that when step 408 in the above-explained prior-art algorithm is completed. When step 408 in the prior-art algorithm and steps 708 and 710 in the present embodiment are compared, it is worth to note, similar to the case of above steps 704 and 706, that, although the number of communication steps is doubled in the present embodiment, the number of used communication links 20 is increased nine-fold, and the size of data transmitted through each communication link 20 is decreased to 1/9 of that of the prior art, so that communication time required for transferring a submatrix is shortened to 2/9 of that of the prior art.

Next, in step 712, each computation node 100 computes a product of matrices ai1*b11 of two submatrices, that is a part of calculation that the computation node is in charge of; and adds, element by element, each element in the obtained product of matrices to each element of the submatrix cij in the data storage area 124 in the memory 120 in the computation node. The above step corresponds to step 410 in the above-explained prior-art algorithm. In this regard, for example, the computation node N1 has obtained the submatrix a11, that is required for the calculation of the product of matrices, by the Scatter communication in step 704 and the Allgather communication in step 706. Also, for example, the computation node N4 has obtained the submatrix a21, that is required for the calculation of the product of matrices, by the Scatter communication in step 704 and the Allgather communication in step 706, and has obtained the submatrix b12 by the Scatter communication in step 708 and the Allgather communication in step 710. Similarly, other computation nodes 100 obtain necessary submatrices by performing Scatter communication and Allgather communication in series. In this manner, respective submatrices aij and bij are transferred from origination computation nodes 100 to destination computation nodes 100 in such a manner that small pieces of data, that are formed by dividing the respective submatrices aij and bij, are relayed by other computation nodes 100 by performing two-step communication comprising Scatter communication and Allgather communication, rather than direct transfer from the origination computation nodes 100 to the destination computation nodes 100.

Next, steps 714-722 are performed in a manner similar to that in above-explained steps 704-712. Steps 714 and 716 are processes for sending the submatrix a12 of the matrix A to the computation nodes N0 and N2, sending the submatrix a22 to the computation nodes N3 and N5, and sending the submatrix a32 to the computation nodes N6 and N8, by performing Scatter communication and Allgather communication similar to those performed in steps 704 and 706. Also, steps 718 and 720 are processes for sending the submatrix b21 of the matrix B to the computation nodes N0 and N6, sending the submatrix b22 to the computation nodes N1 and N7, and sending the submatrix b23 to the computation nodes N2 and N8, by performing Scatter communication and Allgather communication similar to those performed in steps 708 and 710. The above processes are shown respectively in the tables corresponding to the respective steps in FIG. 8. Step 722 is a process wherein each computation node 100 computes a product of matrices ai2*b2j of the submatrices and adds it to the memory 120; and this step corresponds to step 416 in the prior-art algorithm. As a result of completion of step 722, data of ai1*b1j+ai2*b2j is stored, as interim progress data of the submatrix cij at the time, in the data storage area 124 in the memory 120 in each computation node 100.

Next, similar to above-explained steps 704-712 and steps 714-722, steps 724-732 are performed. Steps 724 and 726 are processes for sending the submatrix a13 of the matrix A to the computation nodes N0 and N1, sending the submatrix a23 to the computation nodes N3 and N4, and sending the submatrix a33 to the computation nodes N6 and N7, by performing Scatter communication and Allgather communication similar to those explained above. Also, steps 728 and 730 are processes for sending the submatrix b31 of the matrix B to the computation nodes N0 and N3, sending the submatrix b32 to the computation nodes N1 and N4, and sending the submatrix b33 to the computation nodes N2 and N5, by performing Scatter communication and Allgather communication similar to those explained above. The above processes are shown respectively in the tables corresponding to the respective steps in FIG. 8. Step 732 is a process wherein each computation node 100 computes a product of matrices ai3*b3j of the submatrices and adds it to the memory 120; and this step corresponds to step 422 in the prior-art algorithm. As a result of completion of step 732, data of ai1*b1j+ai2*b2j+ai3*b3j is stored, as final data of the submatrix cij, in the data storage area 124 in the memory 120 in each computation node 100.

As a result, each computation node 100 finally obtains a result of computation with respect to the submatrix cij, wherein the submatrix cij is a part of the matrix C that represents the product of matrices A*B and the computation is that the computation node is in charge of.

Now, evaluation with respect to how much the above parallel computation method relating to the first embodiment of the present invention is speeded up, compared with the parallel computation method using the above-explained prior-art algorithm, will be made. In the above two methods, it is supposed that there is no difference in the computation ability of respective computation nodes 100 and the communication band of respective communication links 20. Further, it is supposed that the number of computation nodes 100, which constitute the parallel computation system 10, is N (as explained above, N=9 in FIG. 1), and the data length of each of submatrices aij and bij is set to the normalized value “1.”

In the case of the prior-art algorithm, broadcast communication is performed in steps 406, 408, 412, 414, 418, and 420, and the total number of times of communication (that is to be represented by M) is 2N^{1/2}. Also, at each time of communication (i.e., in each step), since the submatrix aij or bij is transferred, the data length (that is to be represented by S) transferred at a single time of communication is 1. Thus, the whole relative communication time T (=MS) is 2N^{1/2}. For example, T=16 in the case that N=64.

In the case of the parallel computation method relating to the first embodiment of the present invention, Scatter communication is performed in steps 704, 708, 714, 718, 724, and 728, and Allgather communication is performed in steps 706, 710, 716, 720, 726, and 730, and the total number of times of communication is 2N^{1/2}. Also, since small pieces data, that are formed by dividing the submatrix aij or bij by the number of computation nodes 100, are transferred at each time of communication, the data length transferred at a single time of communication is 1/N. Thus, the whole relative communication time is T=4/N^{1/2}. For example, T=0.5 in the case that N=64.

Thus, the relative communication time in the case that the parallel computation method relating to the first embodiment of the present invention is used is 2/N of that in the case that the prior-art algorithm is used, so that the relative theoretical performance (i.e., 1/T) is speeded up to N/2-fold of that of the prior-art algorithm. In the case that N=64, the parallel computation method relating to the first embodiment of the present invention can realize speeded-up processing that is 32-fold faster than that of the prior-art algorithm.

### Second Embodiment

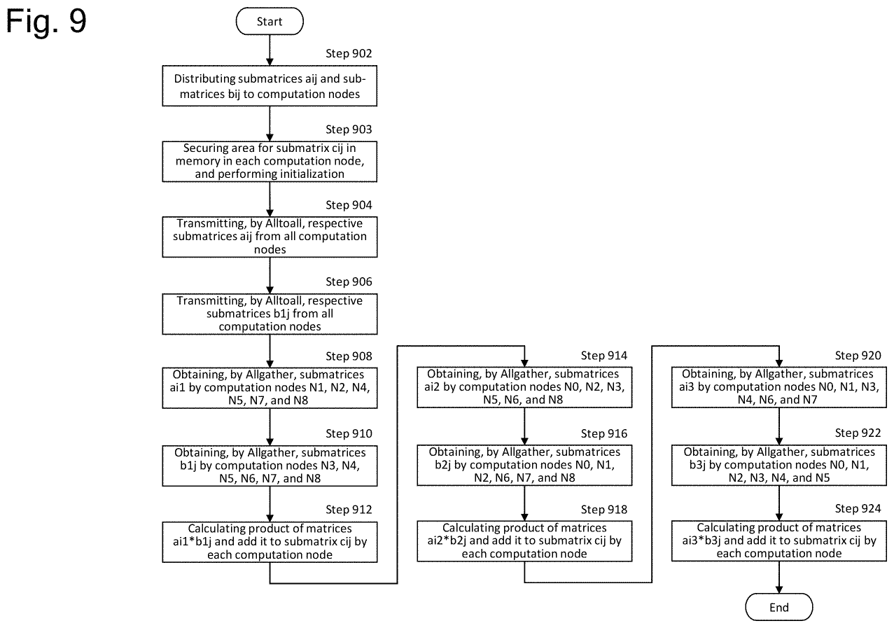

FIG. 9 is a flow chart showing operation of a parallel computation system 10 relating to a second embodiment of the present invention. Also, FIG. 10 visually shows, in the forms of tables, how submatrices are routed between the computation nodes 100 in the second embodiment of the present invention, and the figure corresponds to FIG. 8 in the first embodiment.

A difference between the second embodiment and the first embodiment of the present invention is that, in the second embodiment, the three times of Scatter communication in the first embodiment are aggregated into a single time of “Alltoall communication.” That is, the Scatter communication in steps 704, 714, and 724 is aggregated into “Alltoall communication” in step 904 in the second embodiment, and the Scatter communication in steps 708, 718, and 728 is aggregated into “Alltoall communication” in step 906 in the second embodiment. In this regard, in the flow chart shown in FIG. 9, steps other than steps 904 and 906 are the same as the respective corresponding steps in the flow chart shown in FIG. 7 of the first embodiment. Specifically, steps 902, 903, 908, 910, 912, 914, 916, 918, 920, 922, and 924 of the second embodiment correspond to steps 702, 703, 706, 710, 712, 716, 720, 722, 726, 730, and 732 of the first embodiment, respectively. In the following description, steps 904 and 906 will be explained.

In step 904, all computation nodes 100 transmit submatrices aij, that are held by them respectively, of a matrix A to the all computation nodes 100, by performing “Alltoall communication.” The “Alltoall communication” is that wherein all computation nodes 100 perform, in parallel, processes, wherein each of the processes is that performed by a computation node 100 for dividing data held by the computation node 100 into small pieces of data and transmitting the respective small pieces of data to corresponding computation nodes 100. By the above process, divided parts, that are different from each other, of the all submatrices aij are distributed to different computation nodes 100 simultaneously.

Specifically, for example, the computation node N0 divides a submatrix a11 into nine small pieces of data and transmits the small pieces of data a111, a112, a113, a114, a115, a116, a117, and a118 to the computation nodes N1, N2, N3, N4, N5, N6, N7, and N8, respectively. The above transferring of the respective small pieces of data from the computation node N0 to the respective computation nodes 100 is shown in the top row in the table represented by step 904 in FIG. 10. Also, for example, the computation node N4 divides a submatrix a22 into nine small pieces of data and transmits the small pieces of data a220, a221, a222, a223, a225, a226, a227, and a228 to the computation nodes N0, N1, N2, N3, N5, N6, N7, and N8, respectively. The above transferring of the respective small pieces of data from the computation node N4 to the respective computation nodes 100 is shown in the fifth row, when viewed from the top side, in the table represented by step 904 in FIG. 10. Operation relating to other computation nodes 100 is similar to the above operation, and tangible contents thereof will easily be understood based on the descriptions in the respective rows in the table of step 904 in FIG. 10.

As is apparent from the routing table in FIG. 10, in Alltoall communication, all communication links 20 of the parallel computation system 10 are used, and attention should be payed to the matter that efficient data transfer, wherein the communication band of the parallel computation system 10 is fully used, is realized.

Similarly, in step 906, all computation nodes 100 transmit submatrices bij, that are held by them respectively, of a matrix B to the all computation nodes 100, by performing Alltoall communication. Tangible contents thereof are shown in the table of step 906 in FIG. 10, and will easily be understood by referring to the above explanation relating to step 904 also. In this operation, all communication links 20 of the parallel computation system 10 are also used efficiently by the Alltoall communication.

In this manner, the respective submatrices aij and bij are transferred from origination computation nodes 100 to destination computation nodes 100 in such a manner that small pieces of data of the respective submatrices aij and bij are relayed by other computation nodes 100 by performing two-step communication comprising Alltoall communication and Allgather communication.

In the case of the parallel computation method relating to the second embodiment of the present invention, Alltoall communication is performed in steps 914 and 906, and Allgather communication is performed in steps 908, 910, 914, 916, 920, and 922, and the total number of times of communication is 2+2N^{1/2}. Also, similar to the case of the first embodiment, since small pieces data, that are formed by dividing the submatrix aij or bij by the number of computation nodes 100, are transferred at each time of communication, the data length transferred at a single time of communication is 1/N. Thus, the whole relative communication time is T=(2+2N^{1/2})/N. For example, T=0.28 in the case that N=64.

Thus, the relative communication time in the case that the parallel computation method relating to the second embodiment of the present invention is used is (1+N^{1/2})/(NN^{1/2}) of that in the case that the prior-art algorithm is used, so that the relative theoretical performance is speeded up to (NN^{1/2})/(1+N^{1/2})-fold of that of the prior-art algorithm. In the case that N=64, the parallel computation method relating to the second embodiment of the present invention can realize speeded-up processing that is 57-folds faster than that of the prior-art algorithm.

### Third Embodiment

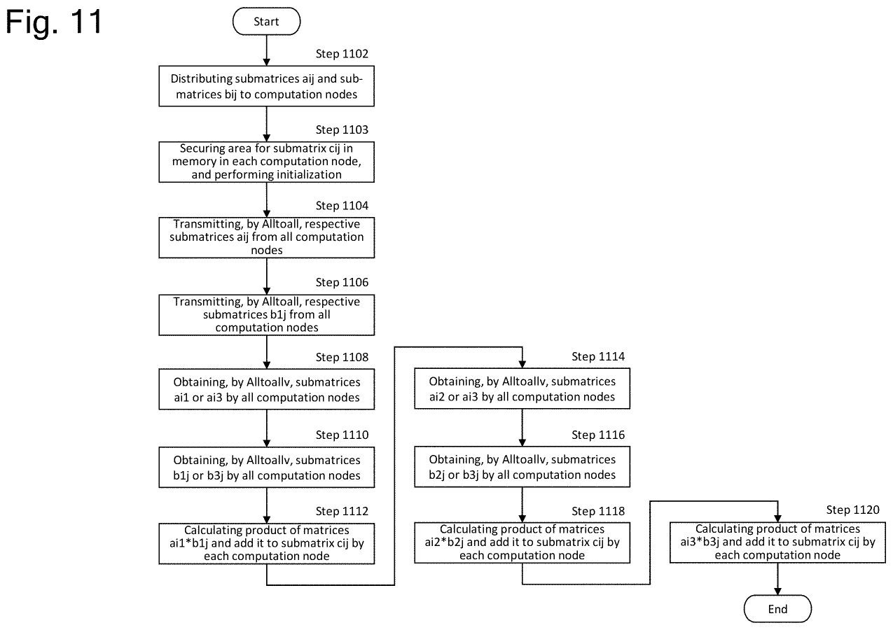

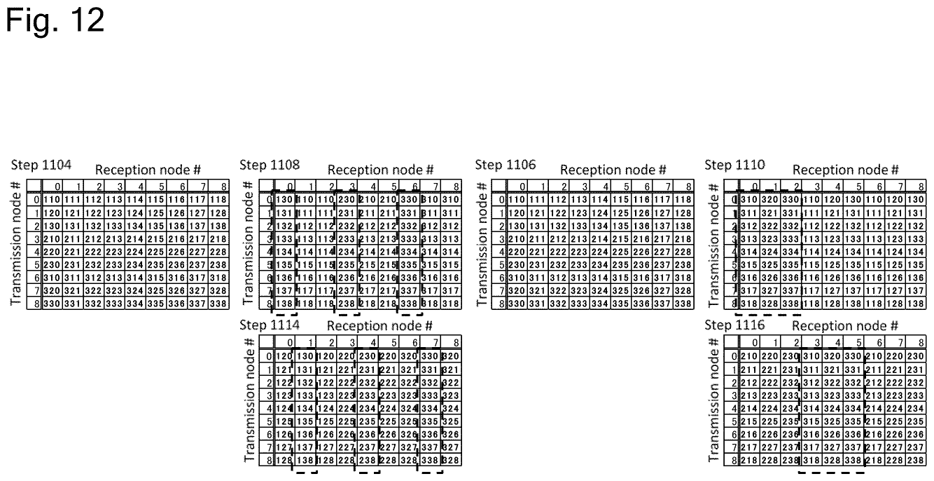

FIG. 11 is a flow chart showing operation of a parallel computation system 10 relating to a third embodiment of the present invention. Also, FIG. 12 visually shows, in the forms of tables, how submatrices are routed between the computation nodes 100 in the third embodiment of the present invention.

The third embodiment of the present invention is that wherein transferring of small pieces of data in the above-explained second embodiment is modified to further improve efficiency thereof. In Allgather communication in steps 908, 910, 914, 916, 920, and 922 in the second embodiment, the whole communication band of the parallel computation system 10 is not completely used. For example, as would be understood from the state that the left-most column of the table of step 908, the fourth column, when viewed from the left side, and the seventh column, when viewed from the left side, in FIG. 10 are shown as those comprised of blank cells, additional data can be transmitted further from all computation nodes 100 to the computation nodes N0, N3, and N6 in parallel with the Allgather communication in the process in step 908.

Thus, a difference between the third embodiment and the second embodiment of the present invention is that, in the third embodiment, the three times of Allgather communication in the second embodiment are aggregated into two times of “Alltoallv communication” by using the above “blank cells.”

Specifically, Alltoallv communication in step 1108 in the third embodiment is that wherein the processes for obtaining, by the computation nodes N0, N3, and N6, respective small pieces of data a13k of a submatrix a13, respective small pieces of data a23k of a submatrix a23, and respective small pieces of data a33k of a submatrix a33 from other respective computation nodes 100, respectively, in the Allgather communication in step 920 in the second embodiment are incorporated in the blank cells in the Allgather communication in step 908 in the second embodiment. The above matter is shown by the frames formed by broken-lines in the table of step 1108 in FIG. 12. Similarly, Alltoallv communication in step 1114 in the third embodiment is that wherein the processes for obtaining, by the computation nodes N1, N4, and N7, respective small pieces of data a13k of the submatrix a13, respective small pieces of data a23k of the submatrix a23, and respective small pieces of data a33k of the submatrix a33 from other respective computation nodes 100, respectively, in the Allgather communication in step 920 in the second embodiment are incorporated in the blank cells in the Allgather communication in step 914 in the second embodiment. The above matter is shown by the frames formed by broken-lines in the table of step 1114 in FIG. 12.

By performing the above Alltoallv communication in step 1108, the computation node N0 obtains the submatrix a13, each of the computation nodes N1 and N2 obtains the submatrix a11, the computation node N3 obtains the submatrix a23, each of the computation nodes N4 and N5 obtains the submatrix a21, the computation node N6 obtains the submatrix a33, and each of the computation nodes N7 and N8 obtains the submatrix a31. Further, by performing the Alltoallv communication in step 1114, the computation node N1 obtains the submatrix a13, each of the computation nodes N0 and N2 obtains the submatrix a12, the computation node N4 obtains the submatrix a23, each of the computation nodes N3 and N5 obtains the submatrix a22, the computation node N7 obtains the submatrix a33, and each of the computation nodes N6 and N8 obtains the submatrix a32.

Further, Alltoallv communication in step 1110 in the third embodiment is that wherein the processes for obtaining, by the computation nodes N0, N1, and N2, respective small pieces of data b31k of a submatrix b31, respective small pieces of data b32k of a submatrix b32, and respective small pieces of data b33k of a submatrix b33 from other respective computation nodes 100, respectively, in the Allgather communication in step 922 in the second embodiment are incorporated in the blank cells in the Allgather communication in step 910 in the second embodiment. The above matter is shown by the frames formed by broken-lines in the table of step 1110 in FIG. 12. Further, Alltoallv communication in step 1116 in the third embodiment is that wherein the processes for obtaining, by the computation nodes N3, N4, and N5, respective small pieces of data b31k of the submatrix b31, respective small pieces of data b32k of the submatrix b32, and respective small pieces of data b33k of the submatrix b33 from other respective computation nodes 100, respectively, in the Allgather communication in step 922 in the second embodiment are incorporated in the blank cells in the Allgather communication in step 916 in the second embodiment. The above matter is shown by the frames formed by broken-lines in the table of step 1116 in FIG. 12.

By performing the above Alltoallv communication in step 1110, the computation node N0 obtains the submatrix b31, the computation node N1 obtains the submatrix b32, the computation node N2 obtains the submatrix b33, each of the computation nodes N3 and N6 obtains the submatrix b11, each of the computation nodes N4 and N7 obtains the submatrix b12, and each of the computation nodes N5 and N8 obtains the submatrix b13. Further, by performing the Alltoallv communication in step 1116, the computation node N3 obtains the submatrix b31, the computation node N4 obtains the submatrix b32, the computation node N5 obtains the submatrix b33, each of the computation nodes N0 and N6 obtains the submatrix b21, each of the computation nodes N1 and N7 obtains the submatrix b22, and each of the computation nodes N2 and N8 obtains the submatrix b23.

In this regard, steps 1102, 1103, 1104, 1106, 1112, 1118, and 1120 in the flow chart shown in FIG. 11 are the same as steps 902, 903, 904, 906, 912, 918, and 924 in the second embodiment, respectively.

As is apparent from the routing table in FIG. 12, in the third embodiment, in any of steps 1104-1110, 1114, and 1116, all communication links 20 of the parallel computation system 10 are used efficiently as a result that Alltoall communication or Alltoallv communication is performed.

In this manner, the respective submatrices aij and bij are transferred from origination computation nodes 100 to destination computation nodes 100 in such a manner that small pieces of data of the respective submatrices aij and bij are relayed by other computation nodes 100 by performing two-step communication comprising Alltoall communication and Alltoallv communication.

As explained above, in the case of the parallel computation method relating to the third embodiment of the present invention, Alltoall communication is performed in steps 1104 and 1106, and Alltoallv communication is performed in steps 1108, 1110, 1114, and 1116, and the total number of times of communication is 2N^{1/2}. Also, similar to the cases of the first and second embodiments, since small pieces data, that are formed by dividing the submatrix aij or bij by the number of computation nodes 100, are transferred at each time of communication, the data length transferred at a single time of communication is 1/N. Thus, the whole relative communication time is T=2/N^{1/2}. For example, T=0.25 in the case that N=64.

Thus, the relative communication time in the case that the parallel computation method relating to the third embodiment of the present invention is used is 1/N of that in the case that the prior-art algorithm is used, so that the relative theoretical performance is speeded up to N-fold of that of the prior-art algorithm.

### Fourth Embodiment

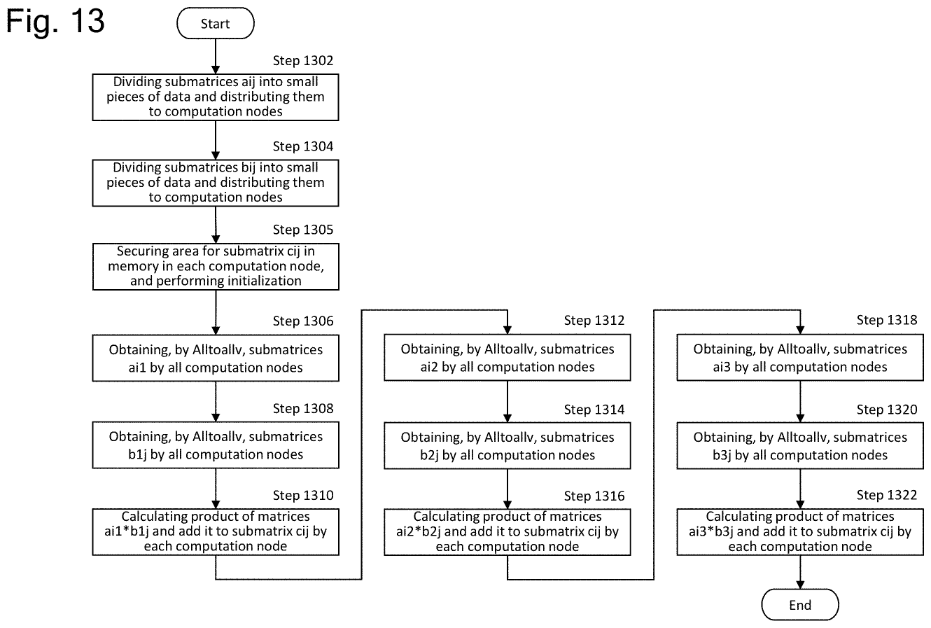

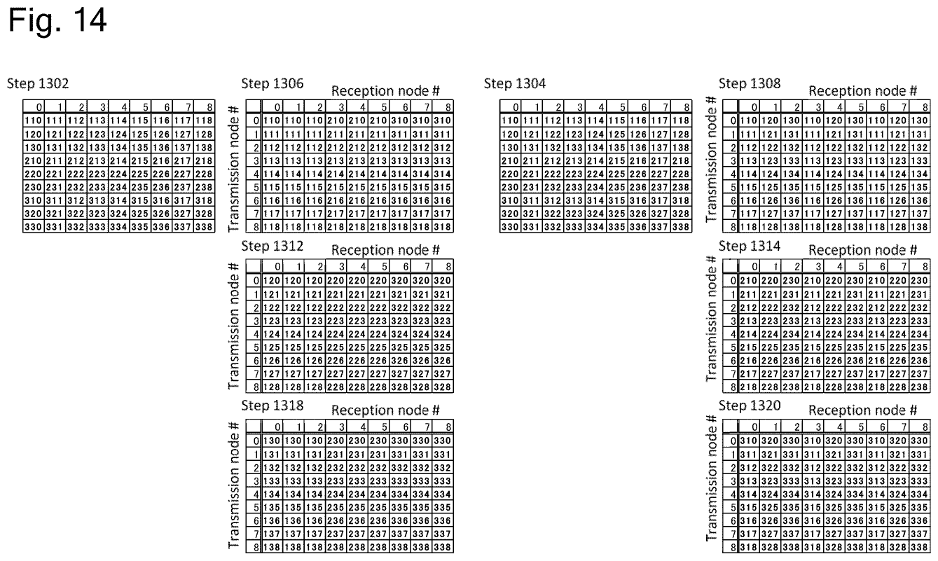

FIG. 13 is a flow chart showing operation of a parallel computation system 10 relating to a fourth embodiment of the present invention. Also, FIG. 14 visually shows, in the forms of tables, initial distribution of data to each of computation nodes 100, and routing between computation nodes 100 in the fourth embodiment of the present invention.

A difference between the fourth embodiment and the above-explained respective embodiments is that, in the fourth embodiment, small pieces of data of submatrices aij and bij are distributed in advance to respective computation nodes 100, in such a manner that the state thereof becomes the same as the state after the submatrices aij of the matrix A are distributed to respective computation nodes 100 by the Alltoall communication in step 904 in the above-explained second embodiment (or step 1104 in the third embodiment) and the submatrices bij of the matrix B are distributed to respective computation nodes 100 by the Alltoall communication in step 906 in the second embodiment (or step 1106 in the third embodiment).

First, in step 1302, respective submatrices aij of the matrix A are divided, respectively, into plural small pieces of data, and the divided small pieces of data are distributed to corresponding computation nodes 100, respectively. Specifically, as shown in the table of step 1302 in FIG. 14, respective small pieces of data a110, a111, a112, a113, a114, a115, a116, a117, and a118, that are formed by dividing a submatrix a11, are distributed to computation nodes computation nodes N0, N1, N2, N3, N4, N5, N6, N7, and N8, respectively. Similarly, small pieces of data of other submatrices aij are distributed to respective computation nodes 100.

As a result of the above initial distribution, for example, the computation node N0 holds the small piece of data a110 of the submatrix a11, the small piece of data a120 of the submatrix a12, the small piece of data a130 of the submatrix a13, the small piece of data a210 of the submatrix a21, the small piece of data a220 of the submatrix a22, the small piece of data a230 of the submatrix a23, the small piece of data a310 of the submatrix a31, the small piece of data a320 of the submatrix a32, and the small piece of data a330 of the submatrix a33. Similarly, the computation node N1 holds the small piece of data a111 of the submatrix a11, the small piece of data a121 of the submatrix a12, the small piece of data a131 of the submatrix a13, the small piece of data a211 of the submatrix a21, the small piece of data a221 of the submatrix a22, the small piece of data a231 of the submatrix a23, the small piece of data a311 of the submatrix a31, the small piece of data a321 of the submatrix a32, and the small piece of data a331 of the submatrix a33. Similar results will be obtained with respect to other computation nodes.

Next, similar to step 1302, in step 1304, respective submatrices bij of the matrix B are divided, respectively, into plural small pieces of data, and the divided small pieces of data are distributed to corresponding computation nodes 100, respectively.

Thereafter, in steps 1306, 1312, and 1318, small pieces of data, that are held by respective computation nodes 100, of the submatrices aij are exchanged between the computation nodes 100 by performing Alltoallv communication, serially.

Specifically, Alltoallv communication in step 1306 is that wherein the processes for obtaining, by the computation nodes N0, N3, and N6, respective small pieces of data a11k of the submatrix a11, respective small pieces of data a21k of the submatrix a21, and respective small pieces of data a31k of the submatrix a31 from respective computation nodes 100, respectively, are incorporated in the blank cells in the Allgather communication in step 908 in the second embodiment. Also, Alltoallv communication in step 1312 is that wherein the processes for obtaining, by the computation nodes N1, N4, and N7, respective small pieces of data a12k of the submatrix a12, respective small pieces of data a22k of the submatrix a22, and respective small pieces of data a32k of the submatrix a32 from respective computation nodes 100, respectively, are incorporated in the blank cells in the Allgather communication in step 914 in the second embodiment. Further, Alltoallv communication in step 1318 is that wherein the processes for obtaining, by the computation nodes N2, N5, and N8, respective small pieces of data a13k of the submatrix a13, respective small pieces of data a23k of the submatrix a23, and respective small pieces of data a33k of the submatrix a33 from respective computation nodes 100, respectively, are incorporated in the blank cells in the Allgather communication in step 920 in the second embodiment.

By performing the Alltoallv communication in step 1306, each of the computation nodes N0, N1 and N2 obtains the submatrix a11, each of the computation nodes N3, N4 and N5 obtains the submatrix a21, and each of the computation nodes N6, N7 and N8 obtains the submatrix a31. Also, by performing the Alltoallv communication in step 1312, each of the computation nodes N0, N1 and N2 obtains the submatrix a12, each of the computation nodes N3, N4 and N5 obtains the submatrix a22, and each of the computation nodes N6, N7 and N8 obtains the submatrix a32. Further, by performing the Alltoallv communication in step 1318, each of the computation nodes N0, N1 and N2 obtains the submatrix a13, each of the computation nodes N3, N4 and N5 obtains the submatrix a23, and each of the computation nodes N6, N7 and N8 obtains the submatrix a33.

Also, in steps 1308, 1314, and 1320, small pieces of data, that are held by respective computation nodes 100, of the submatrices bij are exchanged between the computation nodes 100 by performing Alltoallv communication, serially.

Specifically, Alltoallv communication in step 1308 is that wherein the processes for obtaining, by the computation nodes N0, N1, and N2, respective small pieces of data b11k of the submatrix b11, respective small pieces of data b12k of the submatrix a, and b12 respective small pieces of data b13k of the submatrix b13 from respective computation nodes 100, respectively, are incorporated in the blank cells in the Allgather communication in step 910 in the second embodiment. Also, Alltoallv communication in step 1314 is that wherein the processes for obtaining, by the computation nodes N3, N4, and N5, respective small pieces of data b21k of the submatrix b21, respective small pieces of data b22k of the submatrix b22, and respective small pieces of data b23k of the submatrix b23 from respective computation nodes 100, respectively, are incorporated in the blank cells in the Allgather communication in step 916 in the second embodiment. Further, Alltoallv communication in step 1320 is that wherein the processes for obtaining, by the computation nodes N6, N7, and N8, respective small pieces of data b31k of the submatrix b31, respective small pieces of data b32k of the submatrix b32, and respective small pieces of data b33k of the submatrix b33 from respective computation nodes 100, respectively, are incorporated in the blank cells in the Allgather communication in step 922 in the second embodiment.

By performing the Alltoallv communication in step 1308, each of the computation nodes N0, N3 and N6 obtains the submatrix b11, each of the computation nodes N1, N4 and N7 obtains the submatrix b12, and each of the computation nodes N2, N5 and N8 obtains the submatrix b13. Also, by performing the Alltoallv communication in step 1314, each of the computation nodes N0, N3 and N6 obtains the submatrix b21, each of the computation nodes N1, N4 and N7 obtains the submatrix b22, and each of the computation nodes N2, N5 and N8 obtains the submatrix b23. Further, by performing the Alltoallv communication in step 1320, each of the computation nodes N0, N3 and N6 obtains the submatrix b31, each of the computation nodes N1, N4 and N7 obtains the submatrix b32, and each of the computation nodes N2, N5 and N8 obtains the submatrix b33.

As explained above, in the case of the parallel computation method relating to the fourth embodiment of the present invention, Alltoallv communication is performed in steps 1306, 1308, 1312, 1314, 1318, and 1320, and the total number of times of communication is 2N^{1/2}. Also, similar to the cases of the above-explained embodiments, since small pieces data, that are formed by dividing the submatrix aij or bij by the number of computation nodes 100, are transferred at each time of communication, the data length transferred at a single time of communication is 1/N. Thus, the whole relative communication time is T=2/N^{1/2} that is the same as that in the third embodiment. For example, T=0.25 in the case that N=64.

Thus, the relative communication time in the case that the parallel computation method relating to the fourth embodiment of the present invention is used is 1/N of that in the case that the prior-art algorithm is used, so that the relative theoretical performance is speeded up to N-fold of that of the prior-art algorithm.

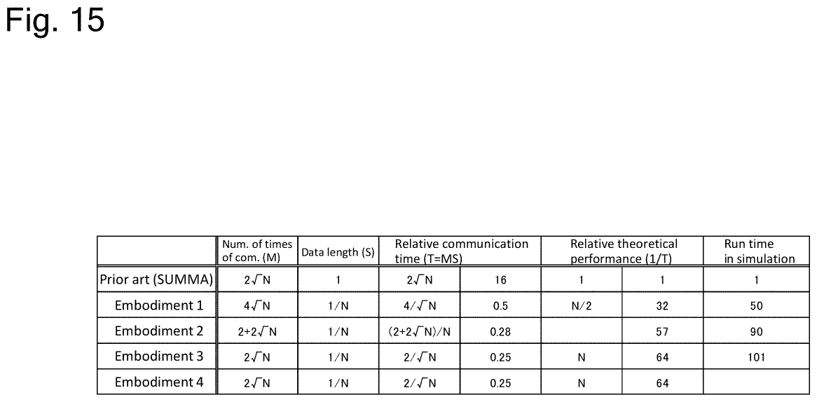

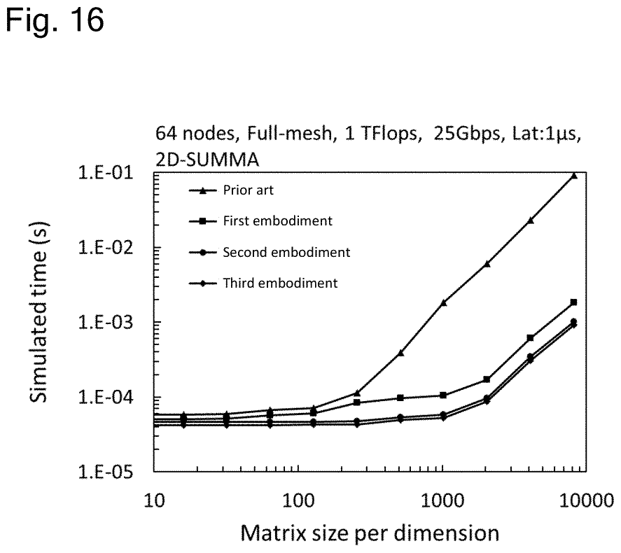

FIG. 15 is a table which summarizes performance of the parallel computation method using the prior-art algorithm and performance of the parallel computation method relating to each of the embodiments of the present invention. Regarding the relative communication time and the relative theoretical performance, values in the case that N=64 are written along therewith. FIG. 16 shows graphs showing results of measurement of run time required for calculation, that are obtained by performing simulation of parallel computation by using the respective methods. The horizontal axis of the graph represents the sizes (i.e., the numbers of rows (columns)) of matrices that are objects of computation, and the vertical axis represents computation run time obtained by performing simulation. In the simulation, a parallel computation system, in which 64 computation nodes 100 are full-mesh connected, is modeled. Results of a simulation in which a matrix having the maximum size is used, among simulations, are shown in the right-most column in the table in FIG. 15. The values show relative performance with respect to the respective methods of the embodiments, when computation run time in the case of the prior-art algorithm is set to 1.

The parallel computation in each of the above-explained embodiments uses, as the basis thereof, SUMMA that is one of prior-art algorithms for matrices product computation. However, the essence of the present invention disclosed in this specification is not limited to application to SUMMA only. Cannon algorithm, Fox algorithm, and so on have been known as other examples of matrices product computation algorithms; and, based on these algorithms, additional embodiments, that are similar to the above-explained embodiments, can be provided.

### Fifth Embodiment

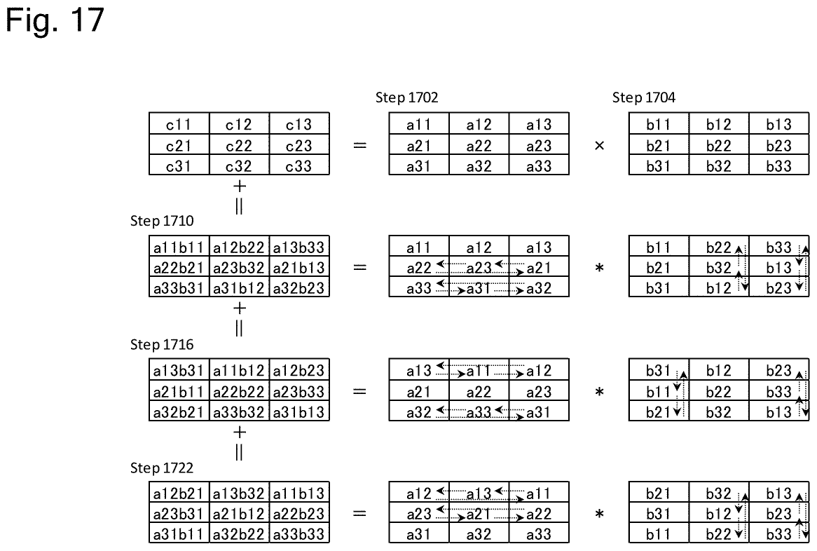

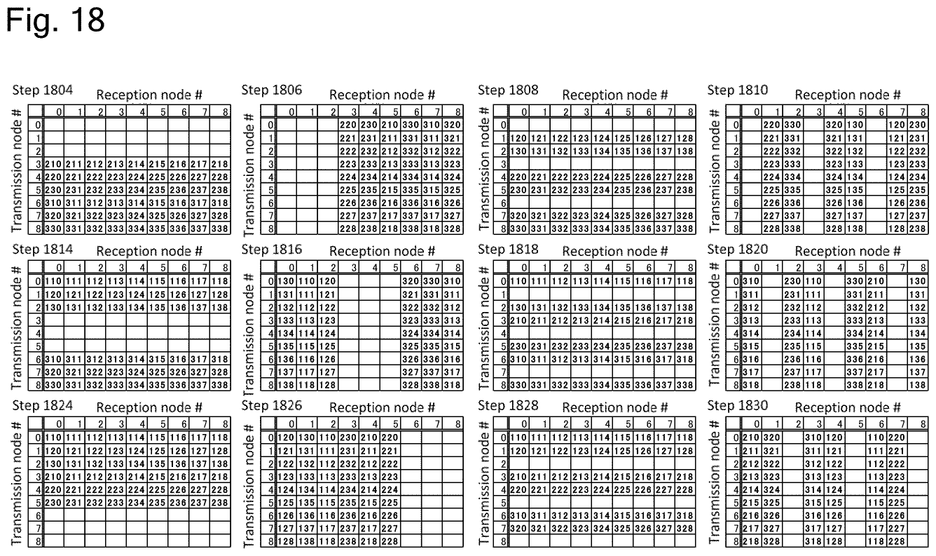

FIG. 17 is a conceptual figure which shows a procedure for executing a matrix operation by use of Cannon algorithm by each computation node 100 in the parallel computation system 10, and the figure corresponds to above-explained FIG. 5 which relates to the case of SUMMA. Also, FIG. 18 shows examples of tables of routing between computation nodes 100, according to the fifth embodiment, that is based on the Cannon algorithm in FIG. 17, of the present invention.

When FIG. 17 and FIG. 18 are referred to, the following operation of the computation node N1, for example, can be seen. The computation node N1 computes a product of matrices a12*b22 in step 1710, by using the submatrix a12 stored in the memory 120 in step 1702 and the submatrix b22 obtained from the computation node N4 in steps 1808 and 1810. Also, the computation node N1 computes a product of matrices a11*b12 in step 1716, by using the submatrix a11 obtained from the computation node N0 in steps 1814 and 1816 and the submatrix b12 stored in the memory 120 in step 1704. Further, the computation node N1 computes a product of matrices a13*b32 in step 1716, by using the submatrix a13 obtained from the computation node N1 in steps 1824 and 1826 and the submatrix b32 obtained from the computation node N7 in steps 1828 and 1830. Operation of computation nodes 100 other than the computation node N1 can be understood similarly, by referring to FIG. 17 and FIG. 18.

### Sixth Embodiment

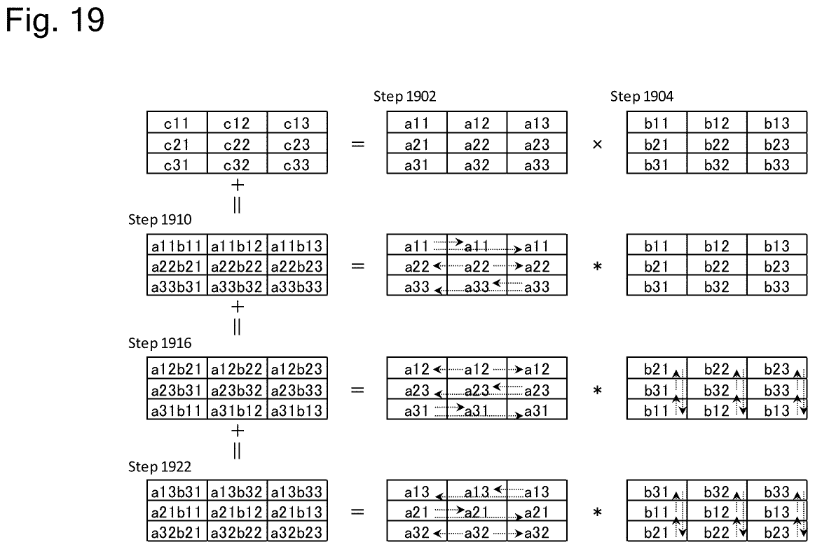

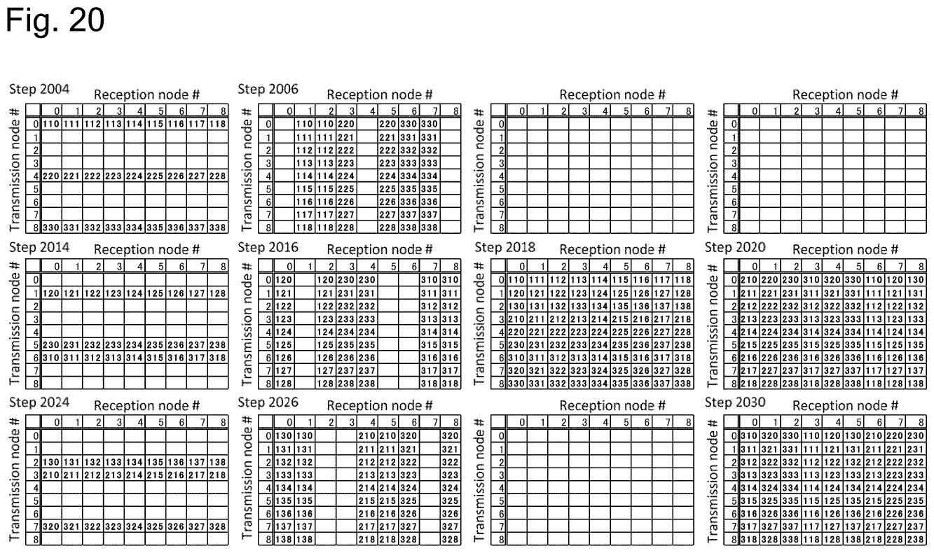

FIG. 19 is a conceptual figure which shows a procedure for executing a matrix operation by use of Fox algorithm by each computation node 100 in the parallel computation system 10. Also, FIG. 20 shows examples of tables of routing between computation nodes 100, according to the sixth embodiment, that is based on the Fox algorithm in FIG. 19, of the present invention.

When FIG. 19 and FIG. 20 are referred to, the following operation of the computation node N1, for example, can be seen. The computation node N1 computes a product of matrices a11*b12 in step 1910, by using the submatrix a11 obtained from the computation node N0 in steps 2004 and 2006 and the submatrix b12 stored in the memory 120 in step 1904. Also, the computation node N1 computes a product of matrices a12*b22 in step 1916, by using the submatrix a12 stored in the memory 120 in step 1902 and the submatrix b22 obtained from the computation node N4 in steps 2018 and 2020. Further, the computation node N1 computes a product of matrices a13*b32 in step 1922, by using the submatrix a13 obtained from the computation node N2 in steps 2024 and 2026 and the submatrix b32 obtained from the computation node N7 in steps 2018 and 2030. Operation of computation nodes 100 other than the computation node N1 can be understood similarly, by referring to FIG. 19 and FIG. 20.

### Seventh Embodiment

In each of the above-explained embodiments, the parallel computation system 10 is constructed to have the form wherein each computation nodes 100 is full-mesh connected to all of other computation nodes 100, as shown in FIG. 1. The connection mode such as that relating to the computation nodes 100 can be referred to as “one-dimensional full-mesh connection.” On the other hand, the present invention can be applied to a parallel computation system in which a connection mode relating to computation nodes 100 is different form the above connection mode.

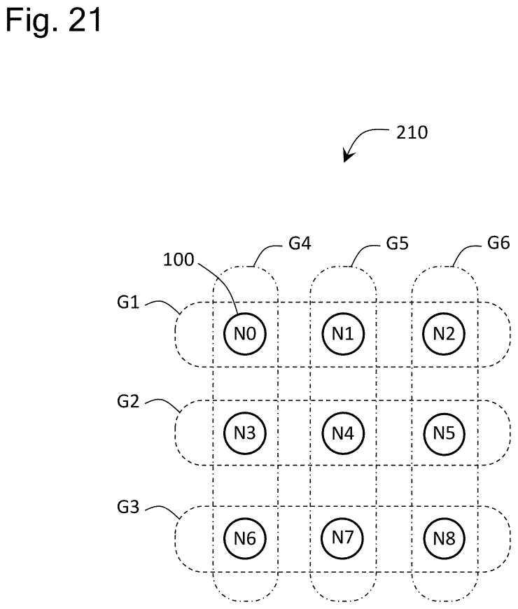

FIG. 21 is a configuration diagram of a parallel computation system 210 relating to another embodiment of the present invention. The parallel computation system 210 comprises plural computation nodes 100. The respective computation nodes 100 are the same as the respective computation nodes 100 in the parallel computation system 10 in FIG. 1. Similar to the case of the parallel computation system 10 in FIG. 1, the parallel computation system 210 comprises nine computation nodes N0-N8 in the example in FIG. 21. In this regard, the number N of computation nodes (provided that N is a square number), that are components of the parallel computation system 210, can be any number.

As shown in the figure, the nine computation nodes N0-N8 in the parallel computation system 210 are divided into three groups G1, G2, and G3, wherein each group comprises three computation nodes 100. The first group G1 comprises computation nodes N0, N1, and N2, the second group G2 comprises computation nodes N3, N4, and N5, and the third group G3 comprises computation nodes N6, N7, and N8. Full-mesh connection between the computation nodes 100 are made in the respective groups. For example, in the first group G1, full-mesh connection between the computation nodes N0, N1, and N2 is made (i.e., one is connected to computation nodes 100 other than the one). Similar connection is made in each of the second group G2 and the third group G3. As a result, three full-mesh connection networks G1, G2, and G3, that do not overlap with each other, are formed.

Further, the nine computation nodes N0-N8 in the parallel computation system 210 are divided into three different groups G4, G5, and G6, wherein each group is different from the above three different groups G1, G2, and G3, and comprises three computation nodes 100. The fourth group G4 comprises computation nodes N0, N3, and N6, the fifth group G5 comprises computation nodes N1, N4, and N7, and the sixth group G6 comprises computation nodes N2, N5, and N8. Similar to the cases of the above groups G1, G2, and G3, full-mesh connection is made in each of the groups G4, G5, and G6. For example, in the fourth group G4, full-mesh connection between the computation nodes N0, N3, and N6 is made. Similar connection is made in each of the fifth group G5 and the sixth group G6. As a result, three full-mesh connection networks G4, G5, and G6, that are independent of the above full-mesh connection networks G1, G2, and G3, are formed.

In this regard, for example, the computation node N0 is a component of the full-mesh connection network G1 which comprises computation nodes arranged in a horizontal direction in FIG. 21, and also is a component of the full-mesh connection network G4 which comprises computation nodes arranged in a vertical direction in FIG. 21. Similarly, any one of the computation nodes 100 is a component of both a full-mesh connection network comprising computation nodes arranged in a horizontal direction in FIG. 21 and a full-mesh connection network comprising computation nodes arranged in a vertical direction in FIG. 21. The connection mode such as that relating to the computation nodes 100 in FIG. 21 can be referred to as “two-dimensional full-mesh connection.”

In this manner, the parallel computation system 210 comprises three full-mesh connection networks G1, G2, and G3, each comprising computation nodes arranged in a horizontal direction in FIG. 21, and three full-mesh connection networks G4, G5, and G6, each comprising computation nodes arranged in a vertical direction in FIG. 21. In each of the full-mesh connection networks, submatrices are divided into small pieces of data and transferred between the computation nodes 100, according to a method similar to any one of those in the above-explained embodiments.

For example, when attention is directed to the full-mesh connection network G1, operation therein is that each of the computation nodes N1, N1, and N2 divides a submatrix a1j, that is held thereby, into three small pieces of data, and transmits the divided small pieces of data to the respective computation nodes 100 in the full-mesh connection network G1 by performing Scatter communication or Alltoall communication. Next, each of the computation nodes N0, N1, and N2 collects the above small pieces of data, that have been distributed in the full-mesh connection network G1 by performing Allgather communication or Alltoallv communication, and reconstructs the original submatrix a1j. Similarly, regarding the full-mesh connection networks G2 and G3, each of submatrices a2j and a3j is divided into small pieces of data, and they are transferred between the computation nodes 100 in the corresponding full-mesh connection network.

On the other hand, in the full-mesh connection network G4, three small pieces of data, that are formed by dividing a submatrix bi1 into three parts, are transferred in a similar manner between the computation nodes N0, N3, and N6. Further, in the full-mesh connection networks G5 and G6, small pieces of data of each of submatrices bi2 and bi3 are transferred in a similar manner between the computation nodes 100.

In this manner, in the parallel computation system 210 in which two-dimensional full-mesh connection of the computation nodes 100 has been made, each of the computation nodes 100 can obtain data, that is required for calculation with respect to a submatrix cij, from other computation nodes 100.

The communication time in the case that Alltoall communication and Alltoallv communication is used for transferring submatrices in the present invention is compared with that in the above-explained third embodiment (it should be reminded that Alltoall communication and Alltoallv communication is used similarly therein). As explained above, in the case of the third embodiment, the number of times of communication is M=2N^{1/2}, and the data length transferred per single time of communication is S=1/N. On the other hand, in the case of the present invention, a submatrix is divided by the number of computation nodes in a single group in the parallel computation system 210 (rather than the number of all computation nodes in the parallel computation system 210), so that the data length transferred per single time of communication is S=1/N^{1/2}. Further, in the case of the present invention, since transferring of a submatrix aij and transferring of a submatrix bij can be performed at the same time by a single time of Alltoall communication or Alltoallv communication, the number of times of communication is M=N^{1/2}. Further, if it is supposed that the communication band per single computation node is a constant value “1,” communication band B per communication link in the third embodiment is B=1/(N−1)≈1/N, since each computation node 100 communicates with other (N−1) computation nodes 100; and, on the other hand, B=½(N^{1/2}−1)≈½N^{1/2} in the present embodiment, since each computation node 100 communicates with other 2(N^{1/2}−1) computation nodes 100. Thus, the total relative communication time T (=MS/B), that is required for transferring all pieces of data, with respect to the present embodiment is equal to that with respect to the third embodiment.

As explained above, the parallel computation system 210 according to the seventh embodiment of the present invention can realize speeded-up processing similar to that in the parallel computation system 10 relating to each of the above-explained embodiments. Further, when it is supposed that wavelength multiplex communication is performed between computation nodes that are connected by adopting full-mesh connection (one-dimensional or two-dimensional), it is required to prepare N different wavelength in the case of the parallel computation system 10 in FIG. 1 which uses one-dimensional full-mesh connection; and, on the other hand, the number of wavelengths that is required in the case of the parallel computation system 210 in FIG. 21, which uses two-dimensional full-mesh connection, is N^{1/2}. In general, there is a limit with respect to a wavelength band that can be used for communication, so that there is a limit with respect to the number of wavelengths that can be used. Thus, if it is supposed that the same number of wavelengths are usable, a parallel computation system 210 having a more number of computation nodes 100 can be constructed by adopting the construction of the two-dimensional full-mesh connection, compared with the case wherein one-dimensional full-mesh connection is adopted. For example, if it is supposed that the number of usable wavelengths is 64, the maximum number of computation nodes 100 that can be included in the parallel computation system 10 in FIG. 1 is 64; and, on the other hand, the maximum number of computation nodes 100 that can be included in the parallel computation system 210 of the seventh embodiment, in which two-dimensional full-mesh connection is adopted, is 4096 (=64²). Thus, according to the seventh embodiment of the present invention, a larger parallel computation system 210 can be constructed, and large-scale parallel computation (for example, matrix operation) can be realized.

### Eighth Embodiment

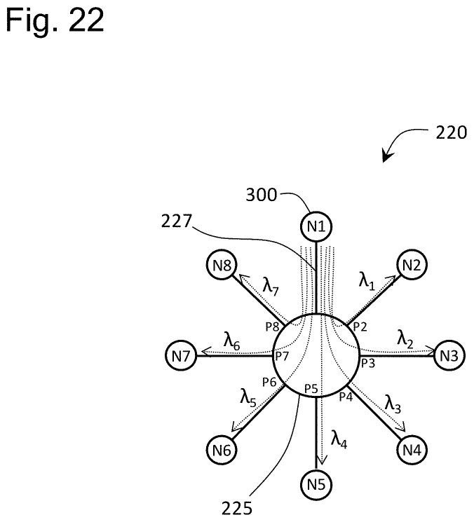

FIG. 22 is a configuration diagram of a parallel computation system 220 relating to an embodiment of the present invention, and shows physical topology between computation nodes 300. Although eight computation nodes 300 are shown in FIG. 22, any number of computation nodes 300 can be included in the parallel computation system 220 as components thereof.

Respective computation nodes 300 are physically connected to a wavelength router 225 by optical fibers 227. The parallel computation system 220 has star-connection-type physical topology wherein all computation nodes 300 are physically connected to the wavelength router 225. Each computation node 300 can communicate with any other computation nodes 300 via the wavelength router 225. Thus, logically, the parallel computation system 220 is constructed to have logical topology of one-dimensional full-mesh connection such as that shown in FIG. 1, or logical topology of two-dimensional full-mesh connection such as that shown in FIG. 21.

The wavelength router 225 comprises plural input/output ports P1-P8, and the respective computation nodes N0-N8 are connected to corresponding input/output ports. An optical signal transmitted from each computation node 300 is inputted to one of the ports P1-P8 of the wavelength router 225. The wavelength router 225 has a function to allocate an optical signal inputted to each port to an output port, that corresponds to the wavelength of the optical signal, in the ports P1-P8. By the above wavelength routing, an optical signal from an origination computation node 300 is routed to a destination computation node 300. For example, as shown in FIG. 22, respective optical signals λ1, λ2, λ3, λ4, λ5, λ6, and λ7 transmitted from the computation node N1 are routed to the computation nodes N2, N3, N4, N5, N6, N7, and N8, respectively.

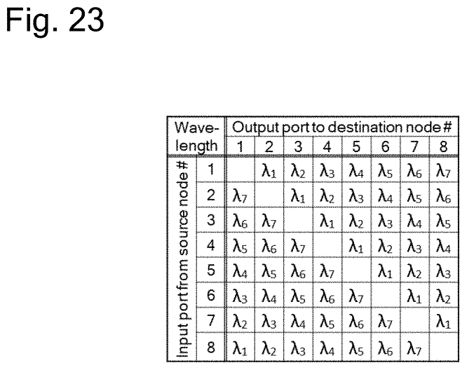

FIG. 23 is a table showing routing by the wavelength router 225. In the case that the above-exemplified computation node N1 is the origination node, it is shown in the top row of the routing table in FIG. 23. Also, for example, it is shown in the second row, when viewed from the top side, in the routing table that respective optical signals λ1, λ2, λ3, λ4, λ5, λ6, and λ7 transmitted from the computation node N2 are routed to the computation nodes N3, N4, N5, N6, N7, N8, and N1, respectively. Regarding the cases wherein the other computation nodes 300 are origination nodes, they can be understood similarly from FIG. 23. The wavelength router 225 having a cyclic wavelength routing function, such as that explained above, can be realized by use of a publicly known passive optical circuit.

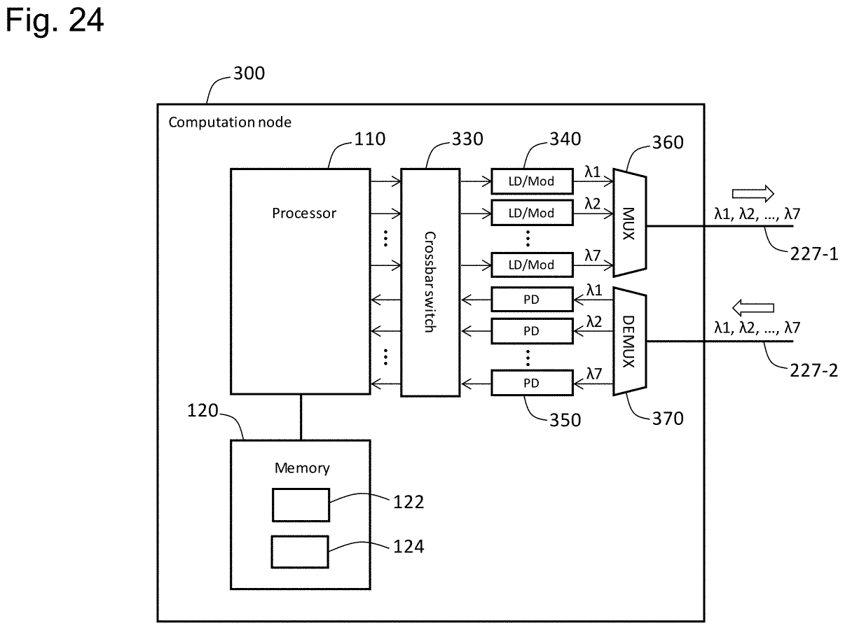

FIG. 24 is a configuration diagram of a computation node 300 applied to the parallel computation system 220 which uses wavelength routing. The computation node 300 comprises a processor 110, a memory 120, a crossbar switch 330, plural light-source/modulator units 340, plural photodetectors 350, a multiplexer 360, and a demultiplexer 370. The processor 110 supplies data, that are objects of transmission, to the respective light-source/modulator units 340 which are prepared to correspond to other computation nodes 300, respectively, via the crossbar switch 330. Each of the light-source/modulator units 340 generates carrier light having a specific wavelength (a wavelength in the wavelengths λ1-λ7, that has been assigned in advance to the light-source/modulator unit 340), modulates the carrier light based on data inputted from the crossbar switch 330, and outputs it to the multiplexer 360. The optical signals having respective wavelengths from the respective light-source/modulator units 340 are wavelength-multiplexed by the multiplexer 360 and sent to a transmitting-side optical fiber 227-1. Also, wavelength-multiplexed optical signals transmitted from other plural computation nodes 300 are inputted, through a receiving-side optical fiber 227-2, to the demultiplexer 370. The wavelength-multiplexed optical signal is subjected to wavelength separation by the demultiplexer 370, and the respective signals having respective wavelengths are received by the photodetectors 350 which have been prepared to correspond to other computation nodes 300, respectively.

In this regard, although data transfer between the memory 120 and the crossbar switch 330 is performed via the processor 110 in FIG. 24, it is possible to install a direct memory access controller (DMAC) between the memory 120 and the crossbar switch 330, off-load the data transfer between the memory 120 and the crossbar switch 330 from the processor 110, and perform the data transfer via the DMAC. Further, although the light-source/modulator unit 340 comprises a light source therein, it is possible to install a light source in the outside of the computation node 300, and input carrier light from the externally installed light source to the light-source/modulator unit 340 via an optical fiber or the like.

In the parallel computation system 220 which is constructed to perform wavelength routing as explained above, it is also possible to perform data communication for parallel computation in a manner similar to those in the above-explained first to seventh embodiments, and speeding up of parallel computation can be achieved thereby.

As explained above, the parallel computation system 220 according to the present embodiment has the construction wherein physical connection between the respective computation nodes 300 is made via the optical fibers 227 and the wavelength router 225, and logical full-mesh connection is made between the respective computation nodes 300 by wavelength routing by the wavelength router 225. In the following description, advantageous points of the above parallel computation system 220, when it is compared with a prior-art parallel computation system in which connection between respective computation nodes is made via a packet switch, will be explained. First, regarding consumption of electric power required for communication between computation nodes, electric power consumption of a prior-art electric-driven packet switch is proportional to throughput ((Line rate)*(Number of ports)); on the other hand, electric power consumption of the wavelength router 225 is independent of throughput, so that, in a state that the throughput is high, electric power consumption of the parallel computation system 220 in the present embodiment is lower than that in the prior art. Next, regarding the number of ports, the upper limit of the number of port in a prior-art electric-driven packet switch is determined mainly based on the number of electric connectors installable on a front panel, and it is approximately 36 per 1U. On the other hand, the number of port in a wavelength router is determined mainly based on the number of wavelengths; so that, when it is supposed that a symbol rate of a signal is 25 GBaud and a distance between channels is 50 GHz, approximately 80 ports can be provided with respect to the whole C-band used in long-distance optical fiber communication. In the case that an MT connector or the like is used as an optical fiber, it is possible to form arrays with a pitch equal to or shorter than 250 μm; and a connector for 160 optical fiber cores, that are required for connecting 80 computation nodes, can be installed within a 1U front panel. Thus, the parallel computation system 220 according to the present embodiment can be downsized further, compared with that of a prior art. Further, regarding easiness of adaption to speeding up of communication speed between computation nodes, a prior-art electric-driven packet switch is dependent on a bit rate and a modulation method, so that it is necessary to change the electric-driven packet switch also when speeding up the communication speed between the computation nodes; on the other hand, the wavelength router 225 can be used continuously as it stands, since it does not include electrical signal processing and is independent of a bit rate and a modulation method. Thus, compared with a prior-art parallel computation system, the parallel computation system 220 according to the present embodiment has advantageous points that it is economical and friendly to the global environment.

The embodiments of the present invention have been explained in the above description; and, in this regard, the present invention is not limited by the above embodiments, and the embodiments can be modified in various ways without departing the scope of the gist of the present invention.

### REFERENCE SIGNS LIST

10 Parallel computation system
20 Communication link
100 Computation node
110 Processor
120 Memory
122 Program storage area
124 Data storage area
130 Transmission/reception unit
132 Communication port
210 Parallel computation system
220 Parallel computation system
225 Wavelength router
227 Optical fiber
300 Computation node
330 Crossbar switch
340 Light-source/modulator unit
350 Photodetector
360 Multiplexer
370 Demultiplexer

1. A method for performing parallel computation in a parallel computation system comprising plural computation nodes, comprising:
a first step for distributing respective first-level small pieces of data, that are formed by dividing data, to the respective computation nodes in the plural computation nodes;
a second step for further dividing, in a first group of computation nodes which includes at least one computation node in the plural computation nodes, the first-level small pieces of data into second-level small pieces of data;
a third step for transferring, in parallel, the respective second-level small pieces of data from the first group of computation nodes to a group of relay nodes which is a subset of the plural computation nodes;
a fourth step for transferring, in parallel, the transferred second-level small pieces of data from the group of relay nodes to a second group of computation nodes which includes at least one computation node in the plural computation nodes; and
a fifth step for reconstructing, in the second group of computation nodes, the first-level small pieces of data by using the second-level small pieces of data transferred from the group of relay nodes.

2. The parallel computation method according to claim 1 further comprising a sixth step for performing a part of the parallel computation by using the reconstructed first-level small pieces of data.

3. The parallel computation method according to claim wherein, in the parallel transfer from the first group of computation nodes in the third step, the first group of computation nodes transfer, in parallel, the respective second-level small pieces of data, in such a manner that all usable communication links between the first group of computation nodes and the group of relay nodes are used.

4. The parallel computation method according to claim 1, wherein, in the parallel transfer to the second group of computation nodes in the fourth step, the group of relay nodes transfer, in parallel, the respective second-level small pieces of data, in such a manner that all usable communication links between the group of relay nodes and the second group of computation nodes are used.

5. The parallel computation method according to claim 1, wherein
each of the computation nodes comprises plural communication ports; and
data communication from the first group of computation nodes to the group of relay nodes in the third step or data communication from the group of relay nodes to the second group of computation nodes in the fourth step is performed via the plural communication ports.

6. The parallel computation method according to claim 1, wherein the plural computation nodes are logically full-mesh connected.

7. The parallel computation method according to claim 1, wherein the parallel computation is matrix operation; the data is data representing a matrix; and the first-level small pieces of data are data representing submatrices formed by dividing the matrix along a row direction and a column direction.

8. The parallel computation method according to claim 7, wherein the submatrices are submatrices formed by dividing the matrix into N pieces (provided that N is the number of computation nodes); and the second-level small pieces of data are data formed by further dividing the submatrix into N pieces.

9. The parallel computation method according to claim 7 wherein the matrix operation is computation of a product of matrices.

10. A method for performing parallel computation in a parallel computation system comprising plural computation nodes, comprising:
a step for further dividing each of first-level small pieces of data, that are formed by dividing data, into second-level small pieces of data;
a step for distributing the respective second-level small pieces of data to the respective computation nodes in the plural computation nodes;
a step for transferring, in parallel, the second-level small pieces of data from the respective computation nodes in the plural computation nodes to at least one computation node in the plural computation nodes; and
a step for reconstructing, in the at least one computation node, the first-level small piece of data by using the second-level small pieces of data transferred from the plural computation nodes.

11. A parallel computation system comprising plural computation nodes, wherein
respective first-level small pieces of data, that are formed by dividing data, are distributed to the respective computation nodes in the plural computation nodes;
at least one first computation node in the plural computation nodes is constructed to
further divide the first-level small piece of data into second-level small pieces of data, and
transfer, in parallel, the respective second-level small pieces of data to a group of relay nodes which is a subset of the plural computation nodes; and
at least one second computation node in the plural computation nodes is constructed to
obtain, by parallel transfer, the second-level small pieces of data from the group of relay nodes, and
reconstruct the first-level small piece of data by using the second-level small pieces of data transferred from the group of relay nodes.

12. A parallel computation system comprising plural computation nodes, wherein
each of first-level small pieces of data, that are formed by dividing data, is further divided into second-level small pieces of data;
the respective second-level small pieces of data are distributed to the respective computation nodes in the plural computation nodes; and
at least one computation node in the plural computation nodes is constructed to
obtain, by parallel transfer, the second-level small pieces of data from the respective computation nodes in the plural computation nodes, and
reconstruct the first-level small piece of data by using the second-level small pieces of data transferred from the plural computation nodes.

13. The parallel computation system according to claim 11, wherein the plural computation nodes are one-dimensional full-mesh connected or two-dimensional full-mesh connected.

14. The parallel computation system according to claim 13, wherein the plural computation nodes are logically full-mesh connected by using wavelength routing.
